(19) United States
(12) Patent Application Publication
(10) Pub. No.: US 2024/0134299 A1
(43) Pub. Date: Apr. 25, 2024

(54) ELECTROSTATIC IMAGE DEVELOPER, PROCESS CARTRIDGE, IMAGE FORMING APPARATUS, AND IMAGE FORMING METHOD

(71) Applicant: FUJIFILM Business Innovation Corp., Tokyo (JP)

(72) Inventors: Moegi IGUCHI, Kanagawa (JP); Sakon TAKAHASHI, Kanagawa (JP); Yasuo KADOKURA, Kanagawa (JP); Takuro WATANABE, Kanagawa (JP); Karin SAKAI, Kanagawa (JP)

(73) Assignee: FUJIFILM Business Innovation Corp., Tokyo (JP)

(21) Appl. No.: 18/300,556

(22) Filed: Apr. 14, 2023

(30) Foreign Application Priority Data
Sep. 22, 2022 (JP) 2022-151969

(51) Int. Cl. G03G 9/097; G03G 9/113; G03G 21/18

(52) U.S. Cl. CPC G03G 9/09708; G03G 9/1135; G03G 21/1814

(57) ABSTRACT

An electrostatic image developer includes: a toner A to which silica particles (A) containing an elemental nitrogen-containing compound containing elemental molybdenum are externally added; and a carrier B including a core material and a coating resin layer that covers the core material and contains inorganic particles. In the silica particles (A), the ratio N_{Mo}/N_{Si} of a Net intensity N_{Mo} of elemental molybdenum that is measured by X-ray fluorescence analysis to a Net intensity N_{Si} of elemental silicon that is measured by the X-ray fluorescence analysis is from 0.035 to 0.45 inclusive.

### CROSS-REFERENCE TO RELATED APPLICATIONS

This application is based on and claims priority under 35 USC 119 from Japanese Patent Application No. 2022-151969 filed Sep. 22, 2022.

### BACKGROUND

### (i) Technical Field

An exemplary embodiment relates to an electrostatic image developer, a process cartridge, an image forming apparatus, and an image forming method.

### (ii) Related Art

Japanese Unexamined Patent Application Publication No. 2021-51149 discloses a carrier for electrostatic image development that includes: a core material; and a coating resin layer that contains inorganic particles and covers the core material, wherein the content of the inorganic particles is from 10% by mass to 60% by mass inclusive based on the total mass of the coating resin layer, and wherein the volume average diameter D (μm) of the inorganic particles and the thickness T (μm) of the coating resin layer satisfy the following relational expression (1):

0.007≤D/T≤0.24. relational expression (1)

Japanese Unexamined Patent Application Publication No. 2021-151944 discloses silica particles containing a quaternary ammonium salt, wherein the ratio F_{BEFORE}/F_{AFTER} of the maximum frequency F_{BEFORE} in a pore diameter range of 2 nm or less in a pore size distribution curve of the silica particles before washing that is determined by the nitrogen gas adsorption method to the maximum frequency F_{AFTER} in a pore diameter range of 2 nm or less in a pore size distribution curve of the silica particles after washing that is determined by the nitrogen gas adsorption method is from 0.90 to 1.10 inclusive, and wherein the ratio F_{SINTERING}/F_{BEFORE} of the maximum frequency F_{SINTERING} in a pore diameter range of 2 nm or less in a pore size distribution curve of the silica particles before washing but after firing at 600° C. that is determined by the nitrogen gas adsorption method to the maximum frequency F_{BEFORE} is from 5 to 20 inclusive.

Japanese Unexamined Patent Application Publication No. 8-123073 discloses a toner for electrostatic image development that includes toner particles and an additive, wherein the additive contains hydrophobic-treated silica and silica treated so as to be positively charged, and wherein the amount of the hydrophobic-treated silica added to the toner, the BET specific surface area of the hydrophobic-treated silica, the amount of the silica treated so as to be positively charged and added to the toner, the BET specific surface area of the silica treated so as to be positively charged, and the volume average particle diameter of the toner particles satisfy a specific relation.

### SUMMARY

Aspects of non-limiting embodiments of the present disclosure relate to an electrostatic image developer including a carrier including a coating resin layer that covers a core material and contains inorganic particles. The electrostatic image developer has a higher image unevenness prevention ability than an electrostatic image developer in which the ratio N_{Mo}/N_{Si} of the Net intensity N_{Mo} of elemental molybdenum measured by X-ray fluorescence analysis to the Net intensity N_{Si} of elemental silicon measured by the X-ray fluorescence analysis is less than 0.035 or more than 0.45.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic image developer including: a toner A to which silica particles (A) containing an elemental nitrogen-containing compound containing elemental molybdenum are externally added; and a carrier B including a core material and a coating resin layer that covers the core material and contains inorganic particles, wherein, in the silica particles (A), the ratio N_{Mo}/N_{Si} of a Net intensity N_{Mo} of elemental molybdenum that is measured by X-ray fluorescence analysis to a Net intensity N_{Si} of elemental silicon that is measured by the X-ray fluorescence analysis is from 0.035 to 0.45 inclusive.

### BRIEF DESCRIPTION OF THE DRAWINGS

An exemplary embodiment of the present disclosure will be described in detail based on the following figures, wherein:

FIG. 1 is a schematic configuration diagram showing an example of an image forming apparatus according to the exemplary embodiment; and

FIG. 2 is a schematic configuration diagram showing an example of a process cartridge detachably attached to the image forming apparatus according to the exemplary embodiment.

### DETAILED DESCRIPTION

An exemplary embodiment will be described below. The description and Examples are illustrative of the exemplary embodiment and are not intended to limit the scope of the exemplary embodiment.

In the exemplary embodiment, a numerical range represented using “to” means a range including the numerical values before and after the “to” as the minimum value and the maximum value, respectively.

In a set of numerical ranges expressed in a stepwise manner in the exemplary embodiment, the upper or lower limit in one numerical range may be replaced with the upper or lower limit in another numerical range in the set. Moreover, in a numerical range described in the exemplary embodiment, the upper or lower limit in the numerical range may be replaced with a value indicated in an Example.

In the exemplary embodiment, the term “step” is meant to include not only an independent step but also a step that is not clearly distinguished from other steps, so long as the prescribed purpose of the step can be achieved.

When the exemplary embodiment is explained with reference to the drawings, the structure of the exemplary embodiment is not limited to the structures shown in the drawings. In the drawings, the sizes of the components are conceptual, and the relative relations between the components are not limited to those shown in the drawings.

In the exemplary embodiment, any component may contain a plurality of materials corresponding to the component. In the exemplary embodiment, when reference is made to the amount of a component in a composition, if the composition contains a plurality of materials corresponding to the component, the amount means the total amount of the plurality of materials in the composition, unless otherwise specified.

In the exemplary embodiment, particles corresponding to a certain component may include a plurality of types of particles. When a plurality of types of particles corresponding to a certain component are present in a composition, the particle diameter of the component is the value for the mixture of the plurality of types of particles present in the composition, unless otherwise specified.

In the exemplary embodiment, the notation “(meth)acrylic” is meant to include “acrylic” and “methacrylic,” and the notation “(meth)acrylate” is meant to include “acrylate” and “methacrylate.”

In the exemplary embodiment, a “toner for electrostatic image development” may be referred to simply as a “toner,” and an “electrostatic image developer” may be referred to simply as a “developer.” A “carrier for electrostatic image development” may be referred to simply as a “carrier.”

### <Electrostatic Image Developer>

An electrostatic image developer according to the present exemplary embodiment includes: a toner A to which silica particles (A) containing an elemental nitrogen-containing compound containing elemental molybdenum are externally added; and a carrier B including a core material and a coating resin layer that covers the core material and contains inorganic particles, wherein, in the silica particles (A), the ratio N_{Mo}/N_{Si} of a Net intensity N_{Mo} of elemental molybdenum that is measured by X-ray fluorescence analysis to a Net intensity N_{Si} of elemental silicon that is measured by the X-ray fluorescence analysis is from 0.035 to 0.45 inclusive.

The toner to which the silica particles (A) containing the elemental nitrogen-containing compound containing elemental molybdenum are externally added is rapidly chargeable even under use conditions such as high-temperature high-humidity conditions at a high area coverage in which the start of charging of the toner is relatively slow, and image unevenness caused by insufficiently charged toner is unlikely to occur.

However, under specific conditions in which high area coverage printing and low area coverage printing are repeated at high temperature and high humidity, the silica particles (A) transfer from the toner to the carrier and stay on the surface of the carrier. Therefore, the charge imparting ability of the carrier deteriorates, and the level of charging and the rapid chargeability deteriorate. This occasionally causes image unevenness.

The electrostatic image developer according to the present exemplary embodiment is a developer including: the toner A to which the silica particles (A) containing elemental molybdenum and having a ratio N_{Mo}/N_{Si} of from 0.035 to 0.45 inclusive are externally added; and the carrier B containing the inorganic particles. In this case, the effect of preventing the inorganic particles from staying on the carrier is obtained, and good image quality with small image unevenness can be provided. The mechanism of this effect may be as follows. When the ratio N_{Mo}/N_{Si} is from 0.035 to 0.45 inclusive, fine irregularities are formed on the surfaces of the silica particles (A). Moreover, since the coating resin layer of the carrier contains the inorganic particles, fine irregularities are formed on the surface of the carrier, so that the silica particles (A) are unlikely to adhere to the surface of the carrier. These effects work synergistically, and the amount of the silica particles (A) staying on the surface of the carrier is reduced. This may be the reason that a narrow charge distribution can be maintained and therefore the electrostatic image developer obtained can have a high image unevenness prevention ability.

The “toner A” may be referred to simply as the “toner,” and the “carrier B” may be referred to simply as the “carrier,” unless otherwise specified.

[[Surface Coverage of Toner Particles in Toner a with Silica Particles (A)]]

In the toner A, the surface coverage Ca of the toner particles with the silica particles (A) is preferably from 5% by area to 70% by area inclusive, more preferably from 10% by area to 60% by area inclusive, and particularly preferably from 10% by area to 50% by area inclusive, from the viewpoint of the image unevenness prevention ability.

A method for measuring the surface coverage Ca is as follows.

An overall image of one toner particle is taken at a magnification of 40000× using a scanning electron microscope (SEM) (S-4800 manufactured by Hitachi High-Technologies Corporation) equipped with an energy dispersive X-ray analyzer (EDX analyzer) (EMAX Evolution X-Max 80 mm² manufactured by HORIBA Ltd.). The external additives present on the surface of the one toner particle are separated by the EDX analysis into the silica particles (A) and inorganic particles other than the silica particles (A) on the basis of the presence of elemental Mo, elemental N, and elemental Si.

The image of the one toner particle is analyzed using image processing analyzer software WinRoof (MITANI CORPORATION) to determine the area of the one toner particle and the total area of the silica particles (A) present on the one toner particle. This image analysis is performed on 100 toner particles to determine the total area of the 100 toner particles and the total area of the silica particles (A) present on the 100 toner particles. The surface coverage Ca is computed from the following formula.

Surface coverage Ca (%) (total area of silica particles (A) present on 100 toner particles/total area of 100 toner particles)×100

[[Surface Coverage Cb of Carrier B with Inorganic Particles]]

The surface coverage Cb of the carrier B with the inorganic particles is preferably from 5% by area to 70% by area inclusive, more preferably from 10% by area to 60% by area inclusive, still more preferably from 20% by area to 60% by area inclusive, and particularly preferably from 30% by area to 50% by area inclusive, from the viewpoint of the image unevenness prevention ability.

The surface coverage of the carrier with the inorganic particles in the present exemplary embodiment is measured using the following method.
(1) An air jet sieve is used to separate the toner and the carrier from the electrostatic image developer containing the silica particles (A) as an external additive of the toner.
(2) The surface coverage Cb of the carrier covered with the inorganic particles after separation from the electrostatic image developer is determined by X-ray photoelectron spectroscopy (XPS) using the following method.

The carrier is observed using a scanning electron microscope (SEM) (S-4800 manufactured by Hitachi High-Technologies Corporation) equipped with an energy dispersive X-ray analyzer (EDX analyzer) (EMAX Evolution X-Max 80 mm² manufactured by HORIBA Ltd.), and an image is taken at a magnification of 40000×. In this case, EDX analysis is used to identify primary particles of the inorganic particles in one image field on the basis of the presence of Si etc. In the SEM observation, an acceleration voltage of 15 kV, an emission current of 20 μA, and a WD of 15 mm are used. In the EDX analysis, a detection time of 60 minutes is used under the above conditions. The image obtained is transferred to an image analyzer (LUZEX III manufactured by NIRECO CORPORATION), and the areas of the particles are determined by image analysis.

The ratio of the total area of the inorganic particles to the total surface area of the carrier (the total area of the inorganic particles/the total surface area of the carrier×100) is defined as the surface coverage Cb of the carrier covered with the inorganic particles after separation from the electrostatic image developer.

### [[Ca/Cb]]

The surface coverage Ca of the toner particles in the toner A with the silica particles (A) and the surface coverage Cb of the carrier B with the inorganic particles satisfy preferably 0.2≤Ca/Cb≤3, more preferably 0.25≤Ca/Cb≤2.0, and particularly preferably 0.25≤Ca/Cb≤1.5, from the viewpoint of the image unevenness prevention ability.

[[Ratio N_{Mo}/N_{Si} in Silica Particles (A)]]

In the present exemplary embodiment, the ratio N_{Mo}/N_{Si} in the silica particles (A) is from 0.035 to 0.45 inclusive.

From the viewpoint of the image unevenness prevention ability, the ratio N_{Mo}/N_{Si} is preferably 0.05 or more, more preferably 0.07 or more, and still more preferably 0.10 or more.

From the viewpoint of the image unevenness prevention ability, the ratio N_{Mo}/N_{Si} is preferably 0.40 or less, more preferably 0.35 or less, and still more preferably 0.30 or less.

The Net intensity N_{Mo} of elemental molybdenum in the silica particles (A) is preferably from 5 kcps to 75 kcps inclusive, more preferably from 7 kcps to 55 kcps inclusive, still more preferably from 8 kcps to 50 kcps inclusive, and yet more preferably from 10 kcps to 40 kcps inclusive, from the viewpoint of narrowing the charge distribution and retainability of the charge distribution.

The Net intensity N_{Mo} of elemental molybdenum and the Net intensity N_{Si} of elemental silicon in the silica particles are measured by the following method.

About 0.5 g of the silica particles are compressed under a load of 6 t for 60 seconds using a compression molding machine to produce a disk with a diameter of 50 mm and a thickness of 2 mm. This disk is used as a sample, and qualitative and quantitative elemental analysis is performed under the following conditions using a scanning X-ray fluorescence analyzer (XRF-1500 manufactured by Shimadzu Corporation) to thereby determine the Net intensities of elemental molybdenum and elemental silicon (unit: kilo counts per second, kcps).
Tube voltage: 40 kV
Tube current: 90 mA
Measurement area (analysis diameter): diameter 10 mm
Measurement time: 30 minutes
Anticathode: rhodium

### (Toner A)

The electrostatic image developer according to the present exemplary embodiment contains the toner A to which the silica particles (A) containing the elemental nitrogen-containing compound containing elemental molybdenum are externally added.

In the toner A, at least the silica particles (A) may be externally added to toner particles containing a binder resin.

The components of the toner according to the present exemplary embodiment, the structure of the toner, and a method for producing the toner will be described in detail. [Toner particles]

The toner particles contain at least a binder resin. The toner particles may further contain a coloring agent, a release agent, and additional additives.

### —Binder Resin—

Examples of the binder resin include: vinyl resins composed of homopolymers of monomers such as styrenes (such as styrene, p-chlorostyrene, and α-methylstyrene), (meth)acrylates (such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (such as acrylonitrile and methacrylonitrile), vinyl ethers (such as vinyl methyl ether and vinyl isobutyl ether), vinyl ketones (such as vinyl methyl ketone, vinyl ethyl ketone, and vinyl isopropenyl ketone), and olefins (such as ethylene, propylene, and butadiene); and vinyl resins composed of copolymers of combinations of two or more of the above monomers.

Other examples of the binder resin include: non-vinyl resins such as epoxy resins, polyester resins, polyurethane resins, polyamide resins, cellulose resins, polyether resins, and modified rosins; mixtures of the non-vinyl resins and the above-described vinyl resins; and graft polymers obtained by polymerizing a vinyl monomer in the presence of any of these resins.

One of these binder resins may be used alone, or two or more of them may be used in combination.

The binder resin may contain a polyester resin.

Examples of the polyester resin include well-known polyester resins.

The binder resin may contain a crystalline resin and an amorphous resin.

The crystalline resin is a resin that exhibits a clear endothermic peak instead of a stepwise endothermic change in differential scanning calorimetry (DSC). The amorphous resin is a resin that exhibits a stepwise endothermic change instead of a clear endothermic peak in differential scanning calorimetry (DSC).

Specifically, the crystalline resin means a resin in which the half width of the endothermic peak measured at a heating rate of 10° C./minute is 10° C. or less, and the amorphous resin means a resin in which the half width exceeds 10° C. or a resin in which no clear endothermic peak is observed.

### —Crystalline Resin—

Examples of the crystalline resin include crystalline polyester resins and crystalline vinyl resins (such as polyalkylene resins and long chain alkyl (meth)acrylate resins). Of these, crystalline polyester resins may be used, from the viewpoint of the mechanical strength of the toner and its low-temperature fixability.

### —Crystalline Polyester Resin

The crystalline polyester resin is, for example, a polycondensation product of a polycarboxylic acid and a polyhydric alcohol. The crystalline polyester resin used may be a commercial product or a synthesized product.

From the viewpoint of facilitating the formation of the crystalline structure in the crystalline polyester resin, a polycondensation product obtained using a linear aliphatic polymerizable monomer may be used rather than a polycondensation product obtained using a polymerizable monomer having an aromatic ring.

Examples of the polycarboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides thereof, and lower alkyl (having, for example, 1 to 5 carbon atoms) esters thereof.

The polycarboxylic acid used may be a combination of a dicarboxylic acid and a tricarboxylic or higher polycarboxylic acid capable of forming a crosslinked or branched structure. Examples of the tricarboxylic acid include aromatic carboxylic acids (such as 1,2,3-benzenetricarboxylic acid, 1,2,4-benzenetricarboxylic acid, and 1,2,4-naphthalene tricarboxylic acid), anhydrides thereof, and lower alkyl (having, for example, 1 to 5 carbon atoms) esters thereof.

The polycarboxylic acid used may be a combination of a dicarboxylic acid, a dicarboxylic acid having a sulfonic acid group, and a dicarboxylic acid having an ethylenic double bond.

One of these polycarboxylic acids may be used alone, or two or more of them may be used in combination.

The polyhydric alcohol is, for example, an aliphatic diol (e.g., a linear aliphatic diol with a main chain having 7 to 20 carbon atoms). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. In particular, the aliphatic diol may be 1,8-octanediol, 1,9-nonanediol, or 1,10-decanediol.

The polyhydric alcohol used may be a combination of a diol and a trihydric or higher polyhydric alcohol capable of forming a crosslinked or branched structure. Examples of the trihydric or higher polyhydric alcohol include glycerin, trimethylolethane, trimethylolpropane, and pentaerythritol.

One of these polyhydric alcohols may be used alone, or two or more of them may be used in combination.

The polyhydric alcohol may contain the aliphatic diol. The ratio of the aliphatic diol in the polyhydric alcohol is preferably 80% by mole or more and more preferably 90% by mole or more.

The melting temperature of the crystalline polyester resin is preferably from 50° C. to 100° C. inclusive, more preferably from 55° C. to 90° C. inclusive, and still more preferably from 60° C. to 85° C. inclusive.

The melting temperature of the crystalline polyester resin is determined using a DSC curve obtained by differential scanning calorimetry (DSC) from “peak melting temperature” described in melting temperature determination methods in “Testing methods for transition temperatures of plastics” in JIS K7121-1987.

The weight average molecular weight (Mw) of the crystalline polyester resin may be from 6000 to 35000 inclusive.

When the toner particles contain the crystalline resin, the ratio of the crystalline resin in the binder resin is preferably from 4% by mass to 50% by mass inclusive, more preferably from 6% by mass to 30% by mass inclusive, and still more preferably from 8% by mass to 20% by mass inclusive, from the viewpoint of the image unevenness prevention ability.

When the toner particles contain the crystalline polyester resin, the ratio of the crystalline polyester resin in the binder resin is preferably from 4% by mass to 50% by mass inclusive, more preferably from 6% by mass to 30% by mass inclusive, and still more preferably from 8% by mass to 20% by mass inclusive, from the viewpoint of the image unevenness prevention ability.

When the mass ratio of the crystalline resin or the crystalline polyester resin in the binder resin is in the above range, the following are obtained, in contrast to the case where the mass ratio is less than or more than the above range. (1) The external additives are prevented from being embedded in the toner particles. (2) The toner can have both storage stability and good fixability simultaneously. (3) The difference in glossiness in a fixed image caused by the differences in fixation conditions (the differences in temperature and pressure) is reduced.

### —Amorphous Resin—

Examples of the amorphous resin include amorphous polyester resins, amorphous vinyl resins (such as styrene acrylic resins), epoxy resins, polycarbonate resins, and polyurethane resins. Of these, amorphous polyester resins and amorphous vinyl resins (in particular, styrene acrylic resins) are preferred, and amorphous polyester resins are more preferred.

### —Amorphous Polyester Resin

The amorphous polyester resin is, for example, a polycondensation product of a polycarboxylic acid and a polyhydric alcohol. The amorphous polyester resin used may be a commercial product or a synthesized product.

Examples of the polycarboxylic acid include aliphatic dicarboxylic acids (such as oxalic acid, malonic acid, maleic acid, fumaric acid, citraconic acid, itaconic acid, glutaconic acid, succinic acid, alkenyl succinic acids, adipic acid, and sebacic acid), alicyclic dicarboxylic acids (such as cyclohexanedicarboxylic acid), aromatic dicarboxylic acids (such as terephthalic acid, isophthalic acid, phthalic acid, and naphthalenedicarboxylic acid), anhydrides thereof, and lower alkyl (having, for example, 1 to 5 carbon atoms) esters thereof. In particular, the polycarboxylic acid may be an aromatic dicarboxylic acid.

The polycarboxylic acid used may be a combination of a dicarboxylic acid and a tricarboxylic or higher polycarboxylic acid capable of forming a crosslinked or branched structure. Examples of the tricarboxylic or higher polycarboxylic acid include trimellitic acid, pyromellitic acid, anhydrides thereof, and lower alkyl (having, for example, 1 to 5 carbon atoms) esters thereof.

One of these polycarboxylic acids may be used alone, or two or more of them may be used in combination.

Examples of the polyhydric alcohol include aliphatic diols (such as ethylene glycol, diethylene glycol, triethylene glycol, propylene glycol, butanediol, hexanediol, and neopentyl glycol), alicyclic diols (such as cyclohexanediol, cyclohexanedimethanol, and hydrogenated bisphenol A), and aromatic diols (such as an ethylene oxide adduct of bisphenol A and a propylene oxide adduct of bisphenol A). In particular, the polyhydric alcohol is preferably an aromatic diol or an alicyclic diol and more preferably an aromatic diol.

The polyhydric alcohol used may be a combination of a diol and a trihydric or higher polyhydric alcohol capable of forming a crosslinked or branched structure. Examples of the trihydric or higher polyhydric alcohol include glycerin, trimethylolpropane, and pentaerythritol.

One of these polyhydric alcohols may be used alone, or two or more of them may be used in combination.

The glass transition temperature (Tg) of the amorphous polyester resin is preferably from 50° C. to 80° C. inclusive and more preferably from 50° C. to 65° C. inclusive.

The glass transition temperature of the amorphous polyester resin is determined using a DSC curve obtained by differential scanning calorimetry (DSC). More specifically, the glass transition temperature is determined from “extrapolated glass transition onset temperature” described in glass transition temperature determination methods in “Testing methods for transition temperatures of plastics” in JIS K 7121-1987.

The weight average molecular weight (Mw) of the amorphous polyester resin is preferably from 5000 to 1000000 inclusive and more preferably from 7000 to 500000 inclusive.

The number average molecular weight (Mn) of the amorphous polyester resin may be from 2000 to 100000 inclusive.

The molecular weight distribution Mw/Mn of the amorphous polyester resin is preferably from 1.5 to 100 inclusive and more preferably from 2 to 60 inclusive.

The weight average molecular weight and number average molecular weight of the amorphous polyester resin are measured by gel permeation chromatography (GPC). In the molecular weight measurement by GPC, a GPC measurement apparatus HLC-8120GPC manufactured by TOSOH Corporation is used. A TSKgel Super HM-M (15 cm) column manufactured by TOSOH Corporation is used, and tetrahydrofuran is used as a solvent. The weight average molecular weight and the number average molecular weight are computed from the measurement results using a molecular weight calibration curve produced using monodispersed polystyrene standard samples.

The amorphous polyester resin is obtained by a well-known production method. Specifically, the amorphous polyester resin is obtained, for example, by the following method. The polymerization temperature is set to from 180° C. to 230° C. inclusive. If necessary, the pressure inside the reaction system is reduced, and the reaction is allowed to proceed while water and alcohol generated during condensation are removed.

When the raw material monomers are not dissolved or not compatible with each other at the reaction temperature, a high-boiling point solvent may be added as a solubilizer to dissolve the monomers. In this case, the polycondensation reaction is performed while the solubilizer is removed by evaporation. When a monomer with poor compatibility is present, the monomer with poor compatibility and an acid or an alcohol to be polycondensed with the monomer are condensed in advance, and then the resulting polycondensation product and the rest of the components are subjected to polycondensation.

The content of the binder resin with respect to the total mass of the toner particles is preferably from 40% by mass to 95% by mass inclusive, more preferably from 50% by mass to 90% by mass inclusive, and still more preferably from 60% by mass to 85% by mass inclusive.

The binder resin may contain non-crosslinked resin particles or crosslinked particles. One type of particles may be used alone, or two or more types may be used in combination.

### —Coloring Agent—

Examples of the coloring agent include: pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine-based dyes, xanthene-based dyes, azo-based dyes, benzoquinone-based dyes, azine-based dyes, anthraquinone-based dyes, thioindigo-based dyes, dioxazine-based dyes, thiazine-based dyes, azomethine-based dyes, indigo-based dyes, phthalocyanine-based dyes, aniline black-based dyes, polymethine-based dyes, triphenylmethane-based dyes, diphenylmethane-based dyes, and thiazole-based dyes.

Other examples include well-known inorganic pigments such as titanium compounds and silica. Still other examples of the coloring agent that can be used include coloring agents having brilliance such as: powders of metals such as aluminum, brass, bronze, nickel, stainless steel, and zinc; coated flake-like inorganic crystalline substances such as mica, barium sulfate, lamellar silicates, and silicates of lamellar aluminum coated with titanium oxide or yellow iron oxide; monocrystalline plate-like titanium oxide; basic carbonates; bismuth oxychloride; natural guanine; flake-like glass powders; and metal-deposited flake-like glass powders.

The coloring agent is not limited to a compound exhibiting absorption in the visible range and may be a compound exhibiting absorption in the near-infrared range such as an aluminum salt-based compound, a naphthalocyanine-based compound, a squarylium-based compound, or a croconium-based compound.

Well-known fluorescent coloring agents may also be used. Specific examples of the fluorescent coloring agents include those listed in paragraph 0027 in Japanese Unexamined Patent Application Publication No. 2021-127431.

In the toner in the present exemplary embodiment, the coloring agent is an optional component. Even when the toner is a transparent toner containing no coloring agent, image unevenness is unlikely to occur.

One of the coloring agents may be used alone, or two or more of them may be used in combination.

The coloring agent used may be optionally subjected to surface treatment or may be used in combination with a dispersant. A plurality of coloring agents may be used in combination.

The content of the coloring agent with respect to the total mass of the toner particles is preferably from 1% by mass to 30% by mass inclusive and more preferably from 3% by mass to 15% by mass inclusive.

### —Release Agent—

Examples of the release agent include: hydrocarbon-based waxes; natural waxes such as carnauba wax, rice wax, and candelilla wax; synthetic and mineral/petroleum-based waxes such as montan wax; and ester-based waxes such as fatty acid esters and montanic acid esters. The release agent used is not limited to the above release agents.

The melting temperature of the release agent is preferably from 50° C. to 110° C. inclusive and more preferably from 60° C. to 100° C. inclusive.

The melting temperature is determined using a DSC curve obtained by differential scanning calorimetry (DSC) from “peak melting temperature” described in melting temperature determination methods in “Testing methods for transition temperatures of plastics” in JIS K7121-1987.

The content of the release agent with respect to the total mass of the toner particles is preferably from 1% by mass to 20% by mass inclusive and more preferably from 5% by mass to 15% by mass inclusive.

### —Additional Additives—

Examples of the additional additives include well-known additives such as a magnetic material, a charge control agent, and an inorganic powder. These additives are contained in the toner particles as internal additives.

[Structure, composition, and characteristics of toner particles]

The toner particles may have a single layer structure or may have a so-called core-shell structure including a core (core particle) and a coating layer (shell layer) covering the core.

When the toner particles have the core-shell structure, it is preferable, from the viewpoint of preventing the external additives from being embedded, that both the core particles and the shell layer contain resin particles, and it is more preferable that both the core particles and the shell layer contain resin particles such that the resin particles are dispersed highly uniformly.

The toner particles having the core-shell structure include, for example: core particles containing a binder resin, resin particles, a coloring agent, and a release agent; and the shell layer containing a binder resin and resin particles.

The volume average particle diameter (D50v) of the core particles is preferably from 2 μm to 10 μm inclusive and more preferably from 4 μm to 6 μm inclusive.

The average particle diameter of the toner particles is measured using Coulter Multisizer II (manufactured by Beckman Coulter, Inc.), and ISOTON-II (manufactured by Beckman Coulter, Inc.) is used as an electrolyte. 0.5 mg to 50 mg of a measurement sample is added to 2 mL of a 5% by mass aqueous solution of a surfactant (which may be sodium alkylbenzenesulfonate), and the mixture is added to 100 mL to 150 mL of the electrolyte. The electrolyte with the sample added thereto is subjected to dispersion treatment for 1 minute using an ultrasonic dispersion apparatus, and then the diameters of particles in the range of 2 μm to 60 μm are measured using an aperture having an aperture diameter of 100 μm in the Coulter Multisizer II. The number of particles sampled is 50000. Based on the particle size distribution measured, a volume distribution or a number distribution is drawn from the small-diameter side, and a particle diameter at a cumulative frequency of 50% is defined as a volume average particle diameter D50v or a number average particle diameter D50p.

The average circularity of the toner particles is preferably from 0.94 to 1.00 inclusive and more preferably from 0.95 to 0.98 inclusive.

The average circularity of the toner particles is determined as the average of the circularities of the toner particles each defined as (the peripheral length of an equivalent circle of the particle)/(the peripheral length of the particle)=(the peripheral length of a circle having the same area as the area of a projection image of the particle)/(the peripheral length of the projection image of the particle)].

The particle image measuring device used is a flow-type particle image analyzer (FPIA-3000 manufactured by SYSMEX Corporation). The number of toner particles sampled is 3500. When the toner contains the external additives, the toner is dispersed in water containing a surfactant, and the dispersion is subjected to ultrasonic treatment to thereby obtain toner particles with the external additives removed therefrom.

### [Silica Particles (A)]

The silica particles (A) contain the elemental nitrogen-containing compound containing elemental molybdenum, and the ratio N_{Mo}/N_{Si} of the Net intensity N_{Mo} of elemental molybdenum to the Net intensity N_{Si} of elemental silicon that are measured by X-ray fluorescence analysis is from 0.035 to 0.45 inclusive.

The “elemental nitrogen-containing compound containing elemental molybdenum” is hereinafter referred to as a “molybdenum/nitrogen-containing compound.”

The amount of the silica particles (A) externally added is preferably from 0.1 parts by mass to 4.0 parts by mass inclusive and more preferably from 0.1 parts by mass to 3.0 parts by mass inclusive based on 100 parts by mass of the toner particles.

The silica particles (A) contain the molybdenum/nitrogen-containing compound. An exemplary structure of the silica particles (A) will be described.

In one exemplary embodiment of the silica particles (A), at least part of the surfaces of silica base particles are coated with a reaction product of a silane coupling agent, and the molybdenum/nitrogen-containing compound adheres to the coating structure of the reaction product. In the present exemplary embodiment, a hydrophobic-treated structure (a structure obtained by treating the silica particles with a hydrophobizing agent) may further adheres to the coating structure of the reaction product. The silane coupling agent is preferably at least one selected from the group consisting of a monofunctional silane coupling agent, a bifunctional silane coupling agent, and a trifunctional silane coupling agent and is more preferably a trifunctional silane coupling agent.

### —Silica Base Particles—

The silica base particles may be dry silica or may be wet silica.

Examples of the dry silica include: combustion method silica (fumed silica) obtained by combusting a silane compound; and deflagration method silica obtained by explosively combusting a metal silicon powder.

Examples of the wet silica include: wet silica obtained through a neutralization reaction of sodium silicate and a mineral acid (precipitated silica synthesized and aggregated under alkaline conditions and gel method silica particles synthesized and aggregated under acidic conditions); colloidal silica obtained by alkalifying and polymerizing acidic silicate; and sol-gel silica obtained by hydrolysis of an organic silane compound (e.g., alkoxysilane). From the viewpoint of narrowing the charge distribution, the silica base particles may be sol-gel silica.

### —Reaction Product of Silane Coupling Agent—

The structure formed from the reaction product of the silane coupling agent (in particular, the reaction product of a trifunctional silane coupling agent) includes a pore structure and has a high affinity for the molybdenum/nitrogen-containing compound. Therefore, the molybdenum/nitrogen-containing compound penetrates deep into the pores, and the amount of the molybdenum/nitrogen-containing compound contained in the silica particles (A) is relatively large.

The surfaces of the silica base particles are negatively chargeable. When the positively chargeable molybdenum/nitrogen-containing compound adheres to the surfaces of the silica base particles, the effect of cancelling excessive negative charges on the silica base particles is obtained. Since the molybdenum/nitrogen-containing compound adheres not to the outermost surfaces of the silica particles (A) but to the inside of the coating structure (i.e., the pore structure) formed from the reaction product of the silane coupling agent, the charge distribution on the silica particles (A) does not extend to the positive charge side, and excessive negative charges on the silica base particles are cancelled, so that the charge distribution on the silica particles (A) is narrowed.

The silane coupling agent may be a compound containing no N (elemental nitrogen). Examples of the silane coupling agent include a silane coupling agent represented by the following formula (TA).

R¹ₙ—Si(OR²)₄₋ₙ Formula (TA)

In formula (TA), R¹ is a saturated or unsaturated aliphatic hydrocarbon group having 1 to 20 carbon atoms or an aromatic hydrocarbon group having 6 to 20 carbon atoms, and R² is a halogen atom or an alkyl group. n is 1, 2, or 3. When n is 2 or 3, the plurality of R¹s may be the same or different. When n is 1 or 2, the plurality of R²s may be the same or different.

Examples of the reaction product of the silane coupling agent include: a reaction product in which all or part of OR²s in formula (TA) are replaced with OH groups; a reaction product in which all or part of groups with OR²s replaced with OH groups are polycondensed; and a reaction product in which all or part of groups with OR²s replaced with OH groups and SiOH groups in the silica base particles are polycondensed.

The aliphatic hydrocarbon group represented by R¹ in formula (TA) may be linear, branched, or cyclic and is preferably linear or branched. The number of carbon atoms in the aliphatic hydrocarbon group is preferably from 1 to 20 inclusive, more preferably from 1 to 18 inclusive, still more preferably from 1 to 12 inclusive, and yet more preferably from 1 to 10 inclusive. The aliphatic hydrocarbon group may be saturated or unsaturated and is preferably a saturated aliphatic hydrocarbon group and more preferably an alkyl group. Any hydrogen atom in aliphatic hydrocarbon group may be replaced with a halogen atom.

Examples of the saturated aliphatic hydrocarbon group include: linear alkyl groups (such as a methyl group, an ethyl group, a propyl group, a butyl group, a pentyl group, a hexyl group, a heptyl group, an octyl group, a nonyl group, a decyl group, a dodecyl group, a hexadecyl group, and an icosyl group); branched alkyl groups (such as an isopropyl group, an isobutyl group, an isopentyl group, a neopentyl group, a 2-ethylhexyl group, a tert-butyl group, a tert-pentyl group, and an iso-pentadecyl group); and cyclic alkyl groups (such as a cyclopropyl group, a cyclopentyl group, a cyclohexyl group, a cycloheptyl group, a cyclooctyl group, a tricyclodecyl group, a norbornyl group, and an adamantyl group).

Examples of the unsaturated aliphatic hydrocarbon group include: alkenyl groups (such as a vinyl group (ethenyl group), a 1-propenyl group, a 2-propenyl group, a 2-butenyl group, a 1-butenyl group, a 1-hexenyl group, a 2-dodecenyl group, and a pentenyl group); and alkynyl groups (such as an ethynyl group, a 1-propynyl group, a 2-propynyl group, a 1-butynyl group, a 3-hexynyl group, and a 2-dodecynyl group).

The number of carbon atoms in the aromatic hydrocarbon group represented by R¹ in formula (TA) is preferably from 6 to 20 inclusive, more preferably from 6 to 18 inclusive, still more preferably from 6 to 12 inclusive, and yet more preferably from 6 to 10 inclusive. Examples of the aromatic hydrocarbon group include a phenylene group, a biphenylene group, a terphenylene group, a naphthalene group, and an anthracene group. Any hydrogen atom in the aromatic hydrocarbon group may be replaced with a halogen atom.

Examples of the halogen atom represented by R² in formula (TA) include a fluorine atom, a chlorine atom, a bromine atom, and an iodine atom, and the halogen atom may be a chlorine atom, a bromine atom, or an iodine atom.

The alkyl group represented by R² in formula (TA) is preferably an alkyl group having 1 to 10 carbon atoms, more preferably an alkyl group having 1 to 8 carbon atoms, and still more preferably an alkyl group having 1 to 4 carbon atoms. Examples of the linear alkyl group having 1 to 10 carbon atoms include a methyl group, an ethyl group, a n-propyl group, a n-butyl group, a n-pentyl group, a n-hexyl group, a n-heptyl group, a n-octyl group, a n-nonyl group, and a n-decyl group. Examples of the branched alkyl group having 3 to 10 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group. Examples of the cyclic alkyl group having 3 to 10 carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (e.g., bicyclic, tricyclic, and spirocyclic) alkyl groups including any of the above monocyclic alkyl groups bonded together. Any hydrogen atom in the alkyl group may be replaced with a halogen atom.

n in formula (TA) is 1, 2, or 3 and is preferably 1 or 2 and more preferably 1.

The silane coupling agent represented by formula (TA) may be a trifunctional silane coupling agent with R¹ being a saturated aliphatic hydrocarbon group having 1 to 20 carbon atoms, R² being a halogen atom or an alkyl group having 1 to 10 carbon atoms, and n being 1.

Examples of the trifunctional silane coupling agent include: vinyltrimethoxysilane, vinyltriethoxysilane, methyltrimethoxysilane, ethyltrimethoxysilane, propyltrimethoxysilane, butyltrimethoxysilane, hexyltrimethoxysilane, n-octyltrimethoxysilane, decyltrimethoxysilane, dodecyltrimethoxysilane, methyltriethoxysilane, ethyltriethoxysilane, butyltriethoxysilane, hexyltriethoxysilane, decyltriethoxysilane, dodecyltriethoxysilane, phenyltrimethoxysilane, o-methylphenyltrimethoxysilane, p-methylphenyltrimethoxysilane, phenyltriethoxysilane, benzyltriethoxysilane, decyltrichlorosilane, and phenyltrichlorosilane (these are compounds in which R¹ in formula (TA) is an unsubstituted aliphatic hydrocarbon group or an unsubstituted aromatic hydrocarbon group); and 3-glycidoxypropyltrimethoxysilane, 7-methacryloxypropyltrimethoxysilane, 7-mercaptopropyltrimethoxysilane, 7-chloropropyltrimethoxysilane, and 7-glycidyloxypropylmethyldimethoxysilane (these are compounds in which R¹ in formula (TA) is a substituted aliphatic hydrocarbon group or a substituted aromatic hydrocarbon group). Any one of these trifunctional silane coupling agents may be used alone, one or two or more of them may be used in combination.

The trifunctional silane coupling agent is preferably an alkyltrialkoxysilane and more preferably an alkyltrialkoxysilane in which R¹ in formula (TA) is an alkyl group having 1 to 20 carbon atoms (preferably 1 to 15 carbon atoms, more preferably 1 to 8 carbon atoms, still more preferably 1 to 4 carbon atoms, and particularly preferably 1 or 2 carbon atoms) and R² is an alkyl group having 1 to 2 carbon atoms.

More specifically, the silane coupling agent forming the coating structure on the surfaces of the silica base particles is preferably at least one trifunctional silane coupling agent selected from the group consisting of alkyltrimethoxysilanes and alkyltriethoxysilanes each having an alkyl group having 1 to 20 carbon atoms,
more preferably at least one trifunctional silane coupling agent selected from the group consisting of alkyltrimethoxysilanes and alkyltriethoxysilanes each having an alkyl group having 1 to 15 carbon atoms,
still more preferably at least one trifunctional silane coupling agent selected from the group consisting of alkyltrimethoxysilanes and alkyltriethoxysilanes each having an alkyl group having 1 to 8 carbon atoms,
yet more preferably at least one trifunctional silane coupling agent selected from the group consisting of alkyltrimethoxysilanes and alkyltriethoxysilanes each having an alkyl group having 1 to 4 carbon atoms, and
particularly preferably at least one trifunctional silane coupling agent selected from the group consisting of methyltrimethoxysilane, ethyltrimethoxysilane, methyltriethoxysilane, and ethyltriethoxysilane.

The amount of the coating structure formed from the reaction product of the silane coupling agent is preferably from 5.5% by mass to 30% by mass inclusive and more preferably from 7% by mass to 22% by mass inclusive based on the total mass of the silica particles (A).

### —Molybdenum/Nitrogen-Containing Compound—

The molybdenum/nitrogen-containing compound is an elemental nitrogen-containing compound containing elemental molybdenum, but excluding ammonia and compounds in gas form at a temperature of 25° C. or lower.

The molybdenum/nitrogen-containing compound may adhere to the inside of the coating structure formed from the reaction product of the silane coupling agent (i.e., the inner side of the pores in the pore structure). One molybdenum/nitrogen-containing compound may be used, or two or more molybdenum/nitrogen-containing compounds may be used.

From the viewpoint of narrowing the charge distribution and retainability of the charge distribution, the molybdenum/nitrogen-containing compound may be at least one selected from the group consisting of quaternary ammonium salts containing elemental molybdenum (particularly, molybdic acid quaternary ammonium salts) and mixtures containing a quaternary ammonium salt and a metal oxide containing elemental molybdenum. In the quaternary ammonium salt containing elemental molybdenum, the bond between an anion containing elemental molybdenum and a cation containing quaternary ammonium is strong, and therefore this quaternary ammonium salt has high charge distribution retainability.

The molybdenum/nitrogen-containing compound may be a compound represented by formula (1) below.

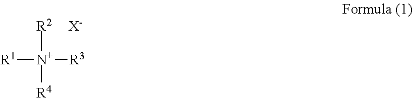

In formula (1), R¹, R², R³, and R⁴ each independently represent a hydrogen atom, an alkyl group, an aralkyl group, or an aryl group, and X⁻ represents a negative ion containing elemental molybdenum. However, at least one of R¹, R², R³, and R⁴ represents an alkyl group, an aralkyl group, or an aryl group. Two or more of R¹, R², R³, and R⁴ may be bonded together to form an aliphatic ring, an aromatic ring, or a heterocycle. The alkyl group, the aralkyl group, and the aryl group may each have a substituent.

Examples of the alkyl groups represented by R¹ to R⁴ include linear alkyl groups having 1 to 20 carbon atoms and branched alkyl groups having 3 to 20 carbon atoms. Examples of the linear alkyl group having 1 to 20 carbon atoms include a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, and a n-hexadecyl group. Examples of the branched alkyl group having 3 to 20 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

The alkyl groups represented by R¹ to R⁴ may each be an alkyl group having 1 to 15 carbon atoms such as a methyl group, an ethyl group, a butyl group, or a tetradecyl group.

Examples of the aralkyl groups represented by R¹ to R⁴ include aralkyl groups having 7 to 30 carbon atoms. Examples of the aralkyl group having 7 to 30 carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

The aralkyl groups represented by R¹ to R⁴ may each be an aralkyl group having 7 to 15 carbon atoms such as a benzyl group, a phenylethyl group, a phenylpropyl group, or a 4-phenylbutyl group.

Examples of the aryl groups represented by R¹ to R⁴ include aryl groups having 6 to 20 carbon atoms. Examples of the aryl group having 6 to 20 carbon atoms include a phenyl group, a pyridyl group, and a naphthyl group.

The aryl groups represented by R¹ to R⁴ may each be an aryl group having 6 to 10 carbon atoms such as a phenyl group.

Examples of the ring formed by bonding two or more of R¹, R², R³, and R⁴ together include alicycles having 2 to 20 carbon atoms and heterocyclic amines having 2 to 20 carbon atoms.

R¹, R², R³, and R⁴ may each independently have a substituent. Examples of the substituent include a nitrile group, a carbonyl group, an ether group, an amido group, a siloxane group, a silyl group, and an alkoxysilane group.

R¹, R², R³, and R⁴ may each independently represent an alkyl group having 1 to 16 carbon atoms, an aralkyl group having 7 to 10 carbon atoms, or an aryl group having 6 to 20 carbon atoms.

The negative ion containing elemental molybdenum and represented by X⁻ is preferably a molybdic acid ion, preferably a molybdic acid ion with molybdenum being tetravalent or hexavalent, and more preferably a molybdic acid ion with molybdenum being hexavalent. Specifically, the molybdic acid ion may be MoO₄²⁻, Mo₂O₇²⁻, Mo₃O₁₀²⁻, Mo₄O₁₃²⁻, Mo₇O₂₄²⁻, or Mo₈O₂₆⁴⁻.

From the viewpoint of narrowing the charge distribution and retainability of the charge distribution, the total number of carbon atoms in the compound represented by formula (1) is preferably from 18 to 35 inclusive and more preferably from 20 to 32 inclusive.

Examples of the compound represented by formula (1) are shown below. However, the present exemplary embodiment is not limited thereto.

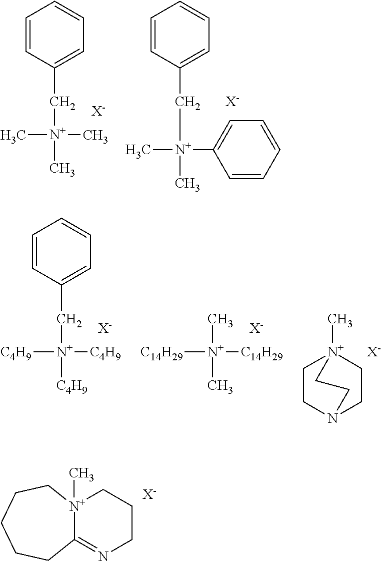

Examples of the quaternary ammonium salt containing elemental molybdenum include molybdic acid quaternary ammonium salts such as [N⁺(CH)₃(Cl₄C₂₉)₂]₄Mo₈O₂₈⁴⁻, [N⁺(C₄H₉)₂(C₆H₆)₂]₂Mo₂O₇²⁻, [N⁺(CH₃)₂(CH₂C₆H₆)(CH₂)₁₇CH₃]₂MoO₄²⁻, and [N⁺(CH₃)₂(CH₂C₆H₆)(CH₂)₁₅CH₃]₂MoO₄²⁻.

Examples of the metal oxide containing elemental molybdenum include molybdenum oxides (molybdenum trioxide, molybdenum dioxide, and Mo₉O₂₆), alkali metal molybdates (lithium molybdate, sodium molybdate, and potassium molybdate), alkaline-earth metal molybdates (magnesium molybdate and calcium molybdate), and other complex oxides (such as Bi₂O₃·2MoO₃ and γ-Ce₂Mo₃O₁₃).

When the silica particles (A) are heated in the temperature range of from 300° C. to 600° C. inclusive, the molybdenum/nitrogen-containing compound is detected. The molybdenum/nitrogen-containing compound can be detected when heated at from 300° C. to 600° C. inclusive in an inert gas and is detected, for example, using a drop-type pyrolysis gas chromatography mass spectrometer of the heating furnace type using He as a carrier gas. Specifically, the silica particles in an amount of from 0.1 mg to 10 mg inclusive are introduced into the pyrolysis gas chromatography mass spectrometer, and the presence or absence of the molybdenum/nitrogen-containing compound is checked from an MS spectrum of detected peaks. Examples of the components generated by pyrolysis of the silica particles containing the molybdenum/nitrogen-containing compound include primary, secondary, and tertiary amines represented by formula (2) below and aromatic nitrogen compounds. R¹, R², and R³ in formula (2) are the same as R¹, R², and R³ in formula (1). When the molybdenum/nitrogen-containing compound is a quaternary ammonium salt, part of its side chains breaks off during the pyrolysis at 600° C., and a tertiary amine is thereby detected.

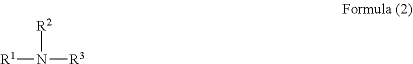

### —Elemental Nitrogen-Containing Compound Containing No Elemental Molybdenum—

In the silica particles (A), an elemental nitrogen-containing compound containing no elemental molybdenum may adhere to the pores in the reaction product of the silane coupling agent. The elemental nitrogen-containing compound containing no elemental molybdenum is, for example, at least one selected from the group consisting of quaternary ammonium salts, primary amine compounds, secondary amine compounds, tertiary amine compounds, amide compounds, imine compounds, and nitrile compounds. The elemental nitrogen-containing compound containing no elemental molybdenum is preferably a quaternary ammonium salt.

Specific examples of the primary amine compound include phenethylamine, toluidine, catecholamine, and 2,4,6-trimethylaniline.

Specific examples of the secondary amine compound include dibenzylamine, 2-nitrodiphenylamine, and 4-(2-octylamino)diphenylamine.

Specific examples of the tertiary amine compound include, 1,8-bis(dimethylamino)naphthalene, N,N-dibenzyl-2-aminoethanol, and N-benzyl-N-methylethanolamine.

Specific examples of the amide compound include N-cyclohexyl-p-toluenesulfonamide, 4-acetamido-1-benzylpiperidine, and N-hydroxy-3-[1-(phenylthio)methyl-1H-1,2,3-triazol-4-yl]benzamide.

Specific examples of the imine compound include diphenylmethanimine, 2,3-bis(2,6-diisopropylphenylimino)butane, and N,N′-(ethane-1,2-diylidene)bis(2,4,6-trimethylaniline).

Specific examples of the nitrile compound include 3-indoleacetonitrile, 4-[(4-chloro-2-pyrimidinyl)amino]benzonitrile, and 4-bromo-2,2-diphenylbutyronitrile.

Examples of the quaternary ammonium salt include compounds represented by formula (AM) below. One of the compounds represented by formula (AM) may be used, or two or more of them may be used.

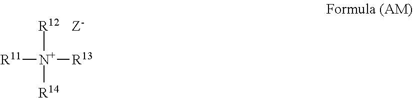

In formula (AM), R¹¹, R¹², R¹³, and R¹⁴ each independently represent a hydrogen atom, an alkyl group, an aralkyl group, or an aryl group, and Z⁻ represents a negative ion. However, at least one of R¹¹, R¹², R¹³, and R¹⁴ represents an alkyl group, an aralkyl group, or an aryl group. Two or more of R¹¹, R¹², R¹³, and R¹⁴ may be bonded together to form an aliphatic ring, an aromatic ring, or a heterocycle. The alkyl group, the aralkyl group, and the aryl group may each have a substituent.

Examples of the alkyl groups represented by R¹¹ to R¹⁴ include linear alkyl groups having 1 to 20 carbon atoms and branched alkyl groups having 3 to 20 carbon atoms. Examples of the linear alkyl group having 1 to 20 carbon atoms include a methyl group, an ethyl group, a n-propyl group, a n-butyl group, a n-pentyl group, a n-hexyl group, a n-heptyl group, a n-octyl group, a n-nonyl group, a n-decyl group, a n-undecyl group, a n-dodecyl group, a n-tridecyl group, a n-tetradecyl group, a n-pentadecyl group, and a n-hexadecyl group. Examples of the branched alkyl group having 3 to 20 carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

The alkyl groups represented by R¹¹ to R¹⁴ may each be an alkyl group having 1 to 15 carbon atoms such as a methyl group, an ethyl group, a butyl group, or a tetradecyl group.

Examples of the aralkyl groups represented by R¹¹ to R¹⁴ include aralkyl groups having 7 to 30 carbon atoms. Examples of the aralkyl group having 7 to 30 carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

The aralkyl groups represented by R¹¹ to R¹⁴ may each be an aralkyl group having 7 to 15 carbon atoms such as a benzyl group, a phenylethyl group, a phenylpropyl group, or a 4-phenylbutyl group.

Examples of the aryl groups represented by R¹¹ to R¹⁴ include aryl groups having 6 to 20 carbon atoms. Examples of the aryl group having 6 to 20 carbon atoms include a phenyl group, a pyridyl group, and a naphthyl group.

The aryl groups represented by R¹¹ to R¹⁴ may each be an aryl group having 6 to 10 carbon atoms such as a phenyl group.

Examples of the ring formed by bonding two or more of R¹¹, R¹², R¹³, and R¹⁴ together include alicycles having 2 to 20 carbon atoms and heterocyclic amines having 2 to 20 carbon atoms.

R¹¹, R¹², R¹³, and R¹⁴ may each independently have a substituent. Examples of the substituent include a nitrile group, a carbonyl group, an ether group, an amido group, a siloxane group, a silyl group, and an alkoxysilane group.

R¹¹, R¹², R¹³, and R¹⁴ may each independently represent an alkyl group having 1 to 16 carbon atoms, an aralkyl group having 7 to 10 carbon atoms, or an aryl group having 6 to 20 carbon atoms.

The negative ion represented by Z⁻ may be an organic negative ion or may be an inorganic negative ion.

Examples of the organic negative ion include polyfluoroalkylsulfonate ions, polyfluoroalkylcarboxylate ions, tetraphenylborate ions, aromatic carboxylate ions, and aromatic sulfonate ions (such as a 1-naphthol-4-sulfonate ion).

Examples of the inorganic negative ion include OH⁻, F⁻, Fe(CN)₆³⁻, Cl⁻, Br⁻, NO₂⁻, NO₃⁻, CO₃²⁻, PO₄³⁻, and SO₄²⁻.

From the viewpoint of narrowing the charge distribution and retainability of the charge distribution, the total number of carbon atoms in the compound represented by formula (AM) is preferably from 18 to 35 inclusive and more preferably from 20 to 32 inclusive.

Examples of the compound represented by formula (AM) are shown below. However, the present exemplary embodiment is not limited thereto.

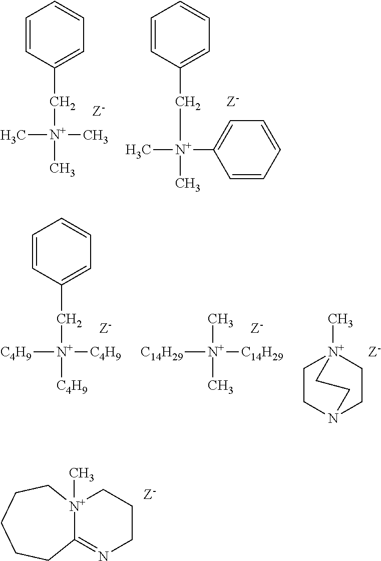

From the viewpoint of narrowing the charge distribution and retainability of the charge distribution, the total amount of the molybdenum/nitrogen-containing compound and the elemental nitrogen-containing compound containing no elemental molybdenum in the silica particles (A) in terms of the mass ratio N/Si of elemental nitrogen to elemental silicon is preferably from 0.005 to 0.50 inclusive, more preferably from 0.008 to 0.45 inclusive, still more preferably from 0.015 to 0.20 inclusive, and yet more preferably from 0.018 to 0.10 inclusive.

The mass ratio N/Si in the silica particles (A) is determined as the mass ratio (N/Si) of N atoms to Si atoms that is measured using an oxygen-nitrogen analyzer (e.g., EMGA-920 manufactured by HORIBA Ltd.) for an integration time of 45 seconds. The sample is subjected to pretreatment, i.e., vacuum drying at 100° C. for 24 hours or longer, to remove impurities such as ammonia.

The total extracted amount X of the molybdenum/nitrogen-containing compound and the elemental nitrogen-containing compound containing no elemental molybdenum that are extracted from the silica particles (A) with an ammonia/methanol solution mixture may be 0.1% by mass or more with respect to 100% by mass of the silica particles. In addition, the total extracted amount X of the molybdenum/nitrogen-containing compound and the elemental nitrogen-containing compound containing no elemental molybdenum that are extracted from the silica particles (A) with the ammonia/methanol solution mixture and the total extracted amount Y of the molybdenum/nitrogen-containing compound and the elemental nitrogen-containing compound containing no elemental molybdenum that are extracted from the silica particles (A) with water (in terms of % by mass with respect to 100% by mass of the silica particles, as is X) may satisfy Y/X<0.3.

The above relation indicates that the elemental nitrogen-containing compound contained in the silica particles (A) does not readily dissolve in water, i.e., does not readily absorb moisture in air. Therefore, when the above relation is satisfied, the charge distribution in the silica particles (A) can be easily narrowed, and the charge distribution retainability is high.

The extracted amount X may be 0.25% by mass or more with respect to 100% by mass of the silica particles. The upper limit of the extracted amount X is, for example, 6.5% by mass or less. The ratio Y/X of the extracted amount Y to the extracted amount X is ideally 0.

The extracted amount X and the extracted amount Y are measured by the following method.

The silica particles are analyzed using a thermogravimetry mass spectrometer (for example, a gas chromatography mass spectrometer manufactured by NETZSCH Japan K.K.) at 400° C. The mass percentage of compounds in which nitrogen atoms and hydrocarbons having one or more carbon atoms are bonded through covalent bonds with respect to the silica particles is measured, integrated, and used as W1.

One part by mass of the silica particles are added to 30 parts by mass of an ammonia/methanol solution (manufactured by Sigma-Aldrich, ammonia/methanol mass ratio=1/5.2) with a solution temperature of 25° C. The mixture is subjected to ultrasonic treatment for 30 minutes, and then the silica powder and the extract are separated from each other. The separated silica particles are dried in a vacuum dryer at 100° C. for 24 hours, and the mass percentage of the compounds in which nitrogen atoms and hydrocarbons having one or more carbon atoms are bonded through covalent bonds with respect to the silica particles is measured at 400° C. using the thermogravimetry mass spectrometer, integrated, and used as W2.

One part by mass of the silica particles are added to 30 parts by mass of water with a solution temperature of 25° C. The mixture is subjected to ultrasonic treatment for 30 minutes, and then the silica powder and the extract are separated from each other. The separated silica particles are dried in a vacuum dryer at 100° C. for 24 hours, and the mass percentage of the compounds in which nitrogen atoms and hydrocarbons having one or more carbon atoms are bonded through covalent bonds with respect to the silica particles is measured at 400° C. using the thermogravimetry mass spectrometer, integrated, and used as W3.
W1 and W2 are used to compute the extracted amount X=W1−W2.
W1 and W3 are used to compute the extracted amount Y=W1−W3.

### —Hydrophobic-Treated Structure—

In the silica particles (A), the hydrophobic-treated structure (the structure formed by treating the silica particles with a hydrophobizing agent) may adhere to the coating structure of the reaction product of the silane coupling agent.

The hydrophobizing agent used may be an organic silicon compound. Examples of the organic silicon compound include the following compounds.

Alkoxysilane compounds and halosilane compounds each having a lower alkyl group such as methyltrimethoxysilane, dimethyldimethoxysilane, trimethylchlorosilane, and trimethylmethoxysilane.

Alkoxysilane compounds each having a vinyl group such as vinyltrimethoxysilane and vinyltriethoxysilane.

Alkoxysilane compounds each having an epoxy group such as 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, and 3-glycidoxypropyltriethoxysilane.

Alkoxysilane compounds each having a styryl group such as p-styryltrimethoxysilane and p-styryltriethoxysilane.

Alkoxysilane compounds each having an aminoalkyl group such as N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, and N-phenyl-3-aminopropyltrimethoxysilane.

Alkoxysilane compounds each having an isocyanatoalkyl group such as 3-isocyanatopropyltrimethoxysilane and 3-isocyanatopropyltriethoxysilane.

Silazane compounds such as hexamethyldisilazane and tetramethyldisilazane.

From the viewpoint of narrowing the charge distribution and retainability of the charge distribution, the silica particles (A) may have the following characteristics.

### —Average Circularity, Average Primary Particle Diameter, and Number-Based Particle Size Distribution Index—

The average circularity of the silica particles (A) is preferably from 0.60 to 0.96 inclusive, more preferably from 0.65 to 0.94 inclusive, still more preferably from 0.70 to 0.92 inclusive, and yet more preferably from 0.75 to 0.90 inclusive.

The silica particles (A) may be monodispersed particles having one peak in a region in which the circularity is more than 0.88 in a circularity distribution of primary particles.

The average primary particle diameter of the silica particles (A) is preferably from 10 nm to 120 nm inclusive, more preferably from 20 nm to 100 nm inclusive, still more preferably from 30 nm to 90 nm inclusive, and particularly preferably from 40 nm to 80 nm inclusive.

The number-based particle size distribution index of the silica particles (A) is preferably from 1.1 to 2.0 inclusive and more preferably from 1.15 to 1.6 inclusive.

The average circularity, average primary particle diameter, and number-based particle size distribution index of the silica particles (A) are measured by the following method. A scanning electron microscope (SEM) (S-4800 manufactured by Hitachi High-Technologies Corporation) equipped with an energy dispersive X-ray analyzer (EDX analyzer) (EMAX Evolution X-Max 80 mm² manufactured by HORIBA Ltd.) is used to capture an image of the toner at a magnification of 40000×. EDX analysis is performed to identify 200 silica particles (A) in one viewing field on the basis of the presence of elemental Mo, elemental N, and elemental Si. The image of the 200 silica particles (A) is analyzed using image processing analyzer software WinRoof (MITANI CORPORATION). The equivalent circle diameter, area, and peripheral length of each of the primary particle images are determined, and then the circularity=4π×(the area of the particle image)/(the peripheral length of the particle image)² is determined. The circularity at a cumulative frequency of 50% cumulated from the small side in the circularity distribution is defined as the average circularity. The equivalent circle diameter at a cumulative frequency of 50% cumulated from the small diameter side in the equivalent circle diameter distribution is defined as the average primary particle diameter. The particle diameter at a cumulative frequency of 16% cumulated from the small diameter side in the equivalent circle diameter distribution is defined as D16, and the particle diameter at a cumulative frequency of 84% is defined as D84. Then the number-based particle size distribution index=(D84/D16)^{0.5} is determined.

### —Hydrophobicity—

The hydrophobicity of the silica particles (A) is preferably from 10% to 60% inclusive, more preferably from 20% to 55% inclusive, and still more preferably from 28% to 53% inclusive.

The hydrophobicity of the silica particles is measured using the following method.

The silica particles are added to 50 mL of ion exchanged water in an amount of 0.2% by mass. While the mixture is stirred using a magnetic stirrer, methanol is added dropwise from a burette, and the mass percentage of methanol in the methanol-water solution mixture at the endpoint at which the entire sample has sunk is determined as the hydrophobicity.

### —Volume Resistivity—

The volume resistivity R of the silica particles (A) is preferably from 1.0×10⁷ Ω·cm to 1.0×10^{12.5} Ω·cm inclusive, more preferably from 1.0×10⁷-Ω·cm to 1.0×10¹² Ω·cm inclusive, still more preferably from 1.0×10⁸ Ω·cm to 1.0×10^{11.5} Ω·cm inclusive, and yet more preferably from 1.0×10⁹ Ω·cm to 1.0×10¹¹ Ω·cm inclusive. The volume resistivity R of the silica particles (A) can be controlled by changing the content of the molybdenum/nitrogen-containing compound.

Let the volume resistivities of the silica particles (A) before and after firing at 350° C. be Ra and Rb, respectively. Then the ratio Ra/Rb is preferably from 0.01 to 0.8 inclusive and more preferably from 0.015 to 0.6 inclusive.

The volume resistivity Ra of the silica particles (A) before firing at 350° C. (which is the same as the volume resistivity R described above) is preferably from 1.0×10⁷ Ω·cm to 1.0×10^{12.5} Ω·cm inclusive, more preferably from 1.0×10^{7.5} Ω·cm to 1.0×10¹² Ω·cm inclusive, still more preferably from 1.0×10⁸ Ω·cm to 1.0×10^{11.5} Ω·cm inclusive, and yet more preferably from 1.0×10⁹ Ω·cm to 1.0×10¹¹ Ω·cm inclusive.

The firing at 350° C. is performed as follows. The silica particles (A) are heated to 350° C. at a heating rate of 10° C./minute in a nitrogen environment, held at 350° C. for 3 hours, and cooled to room temperature (25° C.) at a cooling rate of 10° C./minute.

The volume resistivity of the silica particles (A) is measured in an environment of a temperature of 20° C. and a relative humidity of 50% as follows.

The silica particles (A) are placed to a thickness of about 1 mm to about 3 mm inclusive on a surface of a circular jig with a 20 cm² electrode plate placed thereon to form a silica particle layer. A 20 cm² electrode plate is placed on the silica particle layer to sandwich the silica particle layer between the electrode plates, and a pressure of 0.4 MPa is applied to the electrode plates to eliminate air gaps between the silica particles. Then the thickness L (cm) of the silica particle layer is measured. An impedance analyzer (manufactured by Solartron Analytical) connected to the electrodes on the upper and lower sides of the silica particle layer is used to obtain a Nyquist plot in the frequency range of from 10⁻³ Hz to 106 Hz inclusive. The results are fitted to an equivalent circuit on the assumption that there are three resistance components, i.e., bulk resistance, particle interface resistance, and electrode contact resistance, to thereby determine the bulk resistance R (Ω). The bulk resistance R (Ω) and the thickness L (cm) are used to compute the volume resistivity p (Ω·cm) of the silica particles from the formula ρ=R/L.

### —Number of OH Groups—

The number of OH groups in the silica particles (A) is preferably from 0.05/nm² to 6/nm² inclusive, more preferably from 0.1/nm² to 5.5/nm² inclusive, still more preferably from 0.15/nm² to 5/nm² inclusive, yet more preferably from 0.2/nm² to 4/nm² inclusive, and even more preferably from 0.2/nm² to 3/nm² inclusive.

The number of OH groups on the silica particles is measured by the Sears method as follows.

1.5 g of the silica particles are added to a water 50 g/ethanol 50 g solution mixture, and the mixture is stirred using an ultrasonic homogenizer for 2 minutes to produce a dispersion. While the dispersion is stirred in an environment of 25° C., 1.0 g of a 0.1 mol/L aqueous hydrochloric acid solution is added dropwise to obtain a test solution. The test solution is placed in an automatic titrator, and potentiometric titration is performed using a 0.01 mol/L aqueous sodium hydroxide solution to produce a differential titration curve. A titer at an inflection point at which the derivative of the titration curve is 1.8 or more and the titer of the 0.01 mol/L aqueous sodium hydroxide is maximum is defined as E.

The density p of silanol groups (the number of silanol groups/nm²) on the surfaces of the silica particles is computed from the following formula and used as the number of OH groups on the silica particles.

ρ=((0.01×E-0.1)×NA/1000)/(M×S_{BET}×10¹⁸) Formula:

E: the titer at the inflection point at which the derivative of the titration curve is 1.8 or more and the titer of the 0.01 mol/L aqueous sodium hydroxide is maximum, NA: Avogadro's number, M: the amount of the silica particles (1.5 g), S_{BET}: the BET specific surface area (m²/g) of the silica particles measured by the three-point nitrogen adsorption method (equilibrium relative pressure: 0.3).

### —Pore Diameter—

In the pore size distribution curve determined by the nitrogen gas adsorption method, the silica particles (A) have a first peak preferably in a pore diameter range of from 0.01 nm to 2 nm inclusive and a second peak preferably in a pore diameter range of from 1.5 nm to 50 nm inclusive, more preferably in a range of from 2 nm to 50 nm inclusive, still more preferably in a range of from 2 nm to 40 nm inclusive, and yet more preferably in a range of from 2 nm to 30 nm inclusive.

When the first peak and the second peak are in the above ranges, the molybdenum/nitrogen-containing compound penetrates deep into the pores in the coating structure, and the charge distribution is narrowed.

The pore size distribution curve is determined by the nitrogen gas adsorption method as follows.

The silica particles are cooled to liquid nitrogen temperature (−196° C.), and nitrogen gas is introduced to determine the adsorption amount of the nitrogen gas by the constant volume method or gravimetric method. The pressure of the nitrogen gas introduced is gradually increased, and the amount of nitrogen gas adsorbed is plotted against the equilibrium pressure to produce an adsorption isotherm. A pore diameter distribution curve with the vertical axis representing the frequency and the horizontal axis representing the pore diameter is determined from the adsorption isotherm according to the calculation formula of the BJH method. A cumulative pore volume distribution with the vertical axis representing the volume and the horizontal axis representing the pore diameter is determined from the obtained pore diameter distribution curve, and the positions of pore diameter peaks are checked.

From the viewpoint of narrowing the charge distribution and retainability of the charge distribution, the silica particles (A) may satisfy mode (A) or mode (B) described below.

Mode (A): Let the pore volumes in a pore diameter range of from 1 nm to 50 nm inclusive in the pore size distribution curves determined by the nitrogen gas adsorption method before and after firing at 350° C. be A and B, respectively. Then the ratio B/A is from 1.2 to 5 inclusive, and B is from 0.2 cm³/g to 3 cm³/g inclusive.

The “pore volume A in the pore diameter range of from 1 nm to 50 nm inclusive in the pore size distribution curve determined by the nitrogen gas adsorption method before firing at 350° C.” is referred to as the “pore volume A before firing at 350° C.,” and the pore volume B in the pore diameter range of from 1 nm to 50 nm inclusive in the pore size distribution curve determined by the nitrogen gas adsorption method after firing at 350° C.” is referred to as the “pore volume B after firing at 350° C.”

The firing at 350° C. is performed as follows. The silica particles (A) are heated to 350° C. at a heating rate of 10° C./minute in a nitrogen environment, held at 350° C. for 3 hours, and cooled to room temperature (25° C.) at a cooling rate of 10° C./minute.

The pore volume is measured by the following method.

The silica particles are cooled to liquid nitrogen temperature (−196° C.), and nitrogen gas is introduced to determine the adsorption amount of the nitrogen gas by the constant volume method or gravimetric method. The pressure of the nitrogen gas introduced is gradually increased, and the amount of nitrogen gas adsorbed is plotted against the equilibrium pressure to produce an adsorption isotherm. A pore diameter distribution curve with the vertical axis representing the frequency and the horizontal axis representing the pore diameter is determined from the adsorption isotherm according to the calculation formula of the BJH method. A cumulative pore volume distribution with the vertical axis representing the volume and the horizontal axis representing the pore diameter is determined from the obtained pore diameter distribution curve. The pore volume in the obtained cumulative pore volume distribution is integrated in the pore diameter range of from 1 nm to 50 nm inclusive, and the integrated value is used as the “pore volume in the pore diameter range of from 1 nm to 50 nm inclusive.”

The ratio B/A of the pore volume B after firing at 350° C. to the pore volume A before firing at 350° C. is preferably from 1.2 to 5 inclusive, more preferably from 1.4 to 3 inclusive, and still more preferably from 1.4 to 2.5 inclusive.

The pore volume B after firing at 350° C. is preferably from 0.2 cm³/g to 3 cm³/g inclusive, more preferably from 0.3 cm³/g to 1.8 cm³/g inclusive, and still more preferably from 0.6 cm³/g to 1.5 cm³/g inclusive.

In the mode (A), a sufficient amount of the elemental nitrogen-containing compound is adsorbed to at least part of the pores in the silica particles.

Mode (B): in a ²⁹Si solid nuclear magnetic resonance (NMR) spectrum by the cross-polarization/magic-angle spinning (CP/MAS) method (hereinafter referred to as a “Si-CP/MAS NMR spectrum”), the ratio C/D of the integrated value C of a signal observed in a chemical shift range of from −50 ppm to −75 ppm inclusive to the integrated value D of a signal observed in a chemical shift range of from −90 ppm to −120 ppm inclusive is from 0.10 to 0.75 inclusive.

The Si-CP/MAS NMR spectrum is obtained by performing nuclear magnetic resonance spectrometric analysis under the following conditions.
Spectroscope: AVANCE 300 (manufactured by Bruker)
Resonance frequency: 59.6 MHz
Measurement nucleus: ²⁹Si
Measurement method: CPMAS method (using standard pulse sequence cp.av from Bruker)
Waiting time: 4 seconds
Contact time: 8 milliseconds
Number of scans: 2048
Measurement temperature: room temperature (measured value: 25° C.)
Observation center frequency: −3975.72 Hz
MAS spinning rate: 7.0 mm-6 kHz
Reference material: hexamethylcyclotrisiloxane

The ratio C/D is preferably from 0.10 to 0.75 inclusive, more preferably from 0.12 to 0.45 inclusive, and still more preferably from 0.15 to 0.40 inclusive.

The percentage (signal ratio) of the integrated value C of the signal observed in the chemical shift range of from −50 ppm to −75 ppm inclusive with the integrated value of the entire signal in the Si-CP/MAS NMR spectrum set to 100% is preferably 5% or more and more preferably 7% or more. The upper limit of the percentage of the integrated value C of the signal is, for example, 60% or less.

In the mode (B), the low-density coating structure capable of adsorbing a sufficient amount of the elemental nitrogen-containing compound is formed on at least part of the surfaces of the silica particles. The low-density coating structure is, for example, a coating structure formed from the reaction product of the silane coupling agent (particularly, the trifunctional silane coupling agent) and is, for example, a SiO_{2/3}CH₃ layer.

### [Method for Producing Silica Particles (A)]

An example of a method for producing the silica particles (A) includes: a first step of forming the coating structure formed from the reaction product of the silane coupling agent on at least part of the surfaces of the silica base particles; and a second step of causing the molybdenum/nitrogen-containing compound to adhere to the coating structure. This production method may further include a third step of, after or during the second step, subjecting the silica base particles having the coating structure to hydrophobization treatment. These steps will next be described in detail.

### —Silica Base Particles—

The silica base particles are prepared through step (i) or step (ii) below.

Step (i): the step of preparing a silica base particle suspension by mixing a solvent containing an alcohol and the silica base particles.

Step (ii): the step of obtaining a silica base particle suspension by forming the silica base particles using the sol-gel method.

The silica base particles used in the step (i) may be dry silica or may be wet silica. Specific examples of the silica base particles include sol-gel silica particles, aqueous colloidal silica particles, alcoholic silica particles, fumed silica particles, and fused silica particles.

The alcohol-containing solvent used in the step (i) may be a solvent composed only of the alcohol or may be a solvent mixture of the alcohol and an additional solvent. Examples of the alcohol include lower alcohols such as methanol, ethanol, n-propanol, isopropanol, and butanol. Examples of the additional solvent include: water; ketones such as acetone, methyl ethyl ketone, and methyl isobutyl ketone; cellosolves such as methyl cellosolve, ethyl cellosolve, butyl cellosolve, and cellosolve acetate; and ethers such as dioxane and tetrahydrofuran. When the solvent mixture is used, the ratio of the alcohol is preferably 80% by mass or more and more preferably 85% by mass or more.

The step (ii) may be a sol-gel method including: an alkaline catalyst solution preparing step of preparing an alkaline catalyst solution in which an alkaline catalyst is contained in a solvent containing an alcohol; and a silica base particle forming step of forming the silica base particles by supplying tetraalkoxysilane and an alkaline catalyst to the alkaline catalyst solution.

The alkaline catalyst solution preparing step may be a step of preparing the alcohol-containing solvent and mixing the solvent and the alkaline catalyst to obtain the alkaline catalyst solution.

The alcohol-containing solvent may be a solvent composed only of the alcohol or may be a solvent mixture of the alcohol and an additional solvent. Examples of the alcohol include lower alcohols such as methanol, ethanol, n-propanol, isopropanol, and butanol. Examples of the additional solvent include: water; ketones such as acetone, methyl ethyl ketone, and methyl isobutyl ketone; cellosolves such as methyl cellosolve, ethyl cellosolve, butyl cellosolve, and cellosolve acetate; and ethers such as dioxane and tetrahydrofuran. When the solvent mixture is used, the ratio of the alcohol is preferably 80% by mass or more and more preferably 85% by mass or more.

The alkaline catalyst is a catalyst for facilitating the reactions of the tetraalkoxysilane (hydrolysis and condensation reactions). Examples of the catalyst include basic catalysts such as ammonia, urea, and monoamines, and ammonia may be used.

The concentration of the alkaline catalyst in the alkaline catalyst solution is preferably from 0.5 mol/L to 1.5 mol/L inclusive, more preferably from 0.6 mol/L to 1.2 mol/L inclusive, and still more preferably from 0.65 mol/L to 1.1 mol/L inclusive.

The silica base particle forming step is the step of forming the silica base particles by supplying the tetraalkoxysilane and an alkaline catalyst to the alkaline catalyst solution to allow the reactions (hydrolysis and condensation reactions) of the tetraalkoxysilane to proceed in the alkaline catalyst solution.

In the silica base particle forming step, nuclear particles are formed by the reactions of the tetraalkoxysilane during the initial stage of supply of the tetraalkoxysilane (nuclear particle formation stage), and the nuclear particles are allowed to grow (nuclear particle growth stage), whereby the silica base particles are formed.

Examples of the tetraalkoxysilane include tetramethoxysilane, tetraethoxysilane, tetrapropoxysilane, and tetrabutoxysilane. From the viewpoint of the controllability of the reaction rate and the uniformity of the shapes of the silica base particles to be formed, tetramethoxysilane or tetraethoxysilane may be used.

Examples of the alkaline catalyst supplied to the alkaline catalyst solution include basic catalysts such as ammonia, urea, and monoamines, and ammonia may be used. The alkaline catalyst supplied together with the tetraalkoxysilane may be the same as the alkaline catalyst contained in advance in the alkaline catalyst solution or may be different therefrom. The same alkaline catalyst may be used.

The tetraalkoxysilane and the alkaline catalyst may be supplied continuously to the alkaline catalyst solution or may be supplied intermittently to the alkaline catalyst solution.

In the silica base particle forming step, the temperature of the alkaline catalyst solution (its temperature during supply) is preferably from 5° C. to 50° C. inclusive and more preferably from 15° C. to 45° C. inclusive.

### —First Step—

The first step is the step of forming the coating structure formed from the reaction product of the silane coupling agent by, for example, adding the silane coupling agent to the silica base particle suspension to allow the silane coupling agent to react on the surfaces of the silica base particles.

The silane coupling agent is allowed to react by, for example, after the addition of the silane coupling agent to the silica base particle suspension, heating the suspension under stirring. Specifically, for example, the suspension is heated to from 40° C. to 70° C. inclusive. Then the silane coupling agent is added, and the mixture is stirred. The stirring is continued for preferably from 10 minutes to 24 hours inclusive, more preferably from 60 minutes to 420 minutes inclusive, and still more preferably from 80 minutes to 300 minutes inclusive.

### —Second Step—

The second step may be the step of allowing the molybdenum/nitrogen-containing compound to adhere to the pores in the coating structure formed from the reaction product of the silane coupling agent.

In the second step, for example, the molybdenum/nitrogen-containing compound is added to the silica base particle suspension that has been reacted with the silane coupling agent, and the mixture is stirred while its temperature is maintained in the temperature range of from 20° C. to 50° C. inclusive. The molybdenum/nitrogen-containing compound may be added to the silica particle suspension as an alcohol solution containing the molybdenum/nitrogen-containing compound. The alcohol may be the same alcohol as that contained in the silica base particle suspension or may be different therefrom. The same alcohol may be used. In the alcohol solution containing the molybdenum/nitrogen-containing compound, the concentration of the molybdenum/nitrogen-containing compound is preferably from 0.05% by mass to 10% by mass inclusive and more preferably from 0.1% by mass to 6% by mass inclusive.

### —Third Step—

The third step is the step of causing the hydrophobic-treated structure to further adhere to the coating structure formed from the reaction product of the silane coupling agent. The third step is a hydrophobization treatment step performed after or during the second step. With the hydrophobizing agent, functional groups in the hydrophobizing agent are reacted with each other, and/or the functional groups in the hydrophobizing agent are reacted with OH groups in the silica base particles, so that a hydrophobization treatment layer is formed.

In the third step, for example, the molybdenum/nitrogen-containing compound is added to the silica base particle suspension that has been reacted with the silane coupling agent, and then the hydrophobizing agent is added. In this case, the suspension may be stirred and heated. For example, the suspension is heated to from 40° C. to 70° C. inclusive. Then the hydrophobizing agent is added, and the mixture is stirred. The stirring is continued for preferably from 10 minutes to 24 hours inclusive, more preferably from 20 minutes to 120 minutes inclusive, and still more preferably from 20 minutes to 90 minutes inclusive.

### —Drying Step—

After or during the second step or the third step, a drying step of removing the solvent from the suspension may be performed. Examples of the drying method include thermal drying, spray drying, and supercritical drying.

The spray drying can be performed using a well-known method using a spray dryer (such as a rotary disc-type or nozzle-type dryer). For example, the silica particle suspension is sprayed into a hot gas stream at a rate of from 0.2 L/hour to 1 L/hour inclusive. The temperature of the hot gas is preferably in the range of from 70° C. to 400° C. inclusive at the inlet of the spay dryer and in the range of from 40° C. to 120° C. inclusive at the outlet of the spay dryer. The temperature at the inlet is more preferably in the range of from 100° C. to 300° C. inclusive. The concentration of the silica particles in the silica particle suspension may be from 10% by mass to 30% by mass inclusive.

Examples of the material used as the supercritical fluid for the supercritical drying include carbon dioxide, water, methanol, ethanol, and acetone. From the viewpoint of the efficiency of the treatment and from the viewpoint of reducing the generation of coarse particles, the supercritical fluid may be supercritical carbon dioxide. Specifically, the step using the supercritical carbon dioxide is performed according to the following procedure.

The suspension is placed in a sealed reaction vessel, and then liquid carbon dioxide is introduced into the sealed reaction vessel. The sealed reaction vessel is then heated, and the pressure inside the sealed reaction vessel is increased using a high-pressure pump to bring the carbon dioxide in the sealed reaction vessel into a supercritical state. Next, liquid carbon dioxide is introduced into the sealed reaction vessel so that the supercritical carbon dioxide flows out from the sealed reaction vessel, and the supercritical carbon dioxide is thereby allowed to circulate through the suspension in the sealed reaction vessel. While the supercritical carbon dioxide circulates through the suspension, the solvent is dissolved in the supercritical carbon dioxide and removed together with the supercritical carbon dioxide flowing out from the sealed reaction vessel. The temperature and pressure inside the sealed reaction vessel are those at which carbon dioxide becomes supercritical. The critical point of carbon dioxide is 31.1° C./7.38 MPa. Therefore, the temperature is, for example, from 40° C. to 200° C. inclusive, and the pressure is, for example, from 10 MPa to 30 MPa inclusive. The flow rate of the supercritical fluid into the sealed reaction vessel may be from 80 mL/second to 240 mL/second inclusive.

The silica particles obtained may be pulverized or sieved to remove coarse particles and aggregates. The pulverization is performed using, for example, a dry pulverizing machine such as a jet mill, a vibration mill, a ball mill, or a pin mill. The sieving is performed using, for example, a vibrating sieve or air sieving machine.

### [Additional Additives]

Additional additives other than the silica particles (A) may be externally added to the toner in the present exemplary embodiment. Examples of the additional additives include: particles of inorganic materials such as TiO₂, Al₂O₃, SrTiO₃, BaTiO₃, CaTiO₃, CuO, ZnO, SnO₂, CeO₂, Fe₂O₃, MgO, BaO, CaO, K₂O, Na₂O, ZrO₂, CaO—SiO₂, K₂O·(TiO₂)ₙ, Al₂O₃·2SiO₂, CaCO₃, MgCO₃, BaSO₄, and MgSO₄; hydrophobized inorganic particles obtained by subjecting the above inorganic particles to surface treatment with a hydrophobizing agent; and particles of resins such as polystyrene, polymethyl methacrylate, and melamine resins.

### [Method for Producing Toner]

The toner in the present exemplary embodiment is obtained by producing toner particles and then externally adding external additives to the toner particles produced.

The toner particles may be produced by a dry production method (such as a kneading-grinding method) or by a wet production method (such as an aggregation/coalescence method, a suspension polymerization method, or a dissolution/suspension method). No particular limitation is imposed on the toner particle production method, and any known production method may be used. In particular, the aggregation/coalescence method may be used to obtain the toner particles.

Specifically, when the toner particles are produced, for example, by the aggregation/coalescence method, the toner particles are produced through: the step of preparing a resin particle dispersion in which resin particles used as the binder resin are dispersed (a resin particle dispersion preparing step); the step of aggregating the resin particles (and other optional particles) in the resin particle dispersion (the dispersion may optionally contain an additional particle dispersion mixed therein) to form aggregated particles (an aggregated particle forming step); and the step of heating the aggregated particle dispersion with the aggregated particles dispersed therein to fuse and coalesce the aggregated particles to thereby form the toner particles (a fusion/coalescence step).

These steps will next be described in detail.

In the following, a method for obtaining toner particles containing the coloring agent and the release agent will be described, but the coloring agent and the release agent are used optionally. Of course, an additional additive other than the coloring agent and the release agent may be used.

### —Resin Particle Dispersion Preparing Step—

The resin particle dispersion in which the resin particles used as the binder resin are dispersed is prepared, and, for example, a coloring agent particle dispersion in which coloring agent particles are dispersed and a release agent particle dispersion in which release agent particles are dispersed are prepared.

The resin particle dispersion is prepared, for example, by dispersing the resin particles in a dispersion medium using a surfactant.

Examples of the dispersion medium used for the resin particle dispersion include aqueous mediums.

Examples of the aqueous medium include: water such as distilled water and ion exchanged water; and alcohols. Any of these may be used alone or in combination of two or more.

Examples of the surfactant include: anionic surfactants such as sulfate-based surfactants, sulfonate-based surfactants, phosphate-based surfactants, and soap-based surfactants; cationic surfactants such as amine salt-based surfactants and quaternary ammonium salt-based surfactants; and nonionic surfactants such as polyethylene glycol-based surfactants, alkylphenol ethylene oxide adduct-based surfactants, and polyhydric alcohol-based surfactants. Of these, an anionic surfactant or a cationic surfactant may be used. A nonionic surfactant may be used in combination with the anionic surfactant or the cationic surfactant.

Any of these surfactants may be used alone or in combination of two or more.

To disperse the resin particles in the dispersion medium to form the resin particle dispersion, a commonly used dispersing method that uses, for example, a rotary shearing-type homogenizer, a ball mill using media, a sand mill, or a dyno-mill may be used. The resin particles may be dispersed in the dispersion medium by a phase inversion emulsification method, but this depends on the type of resin particles. In the phase inversion emulsification method, the resin to be dispersed is dissolved in a hydrophobic organic solvent that can dissolve the resin, and a base is added to an organic continuous phase (O phase) to neutralize it. Then the aqueous medium (W phase) is added to change the form of the resin from W/O to O/W, and the resin is thereby dispersed as particles in the aqueous medium.

The volume average diameter of the resin particles dispersed in the resin particle dispersion is, for example, preferably from 0.01 μm to 1 μm inclusive, more preferably from 0.08 μm to 0.8 μm inclusive, and still more preferably from 0.1 μm to 0.6 μm inclusive.

The volume average particle diameter of the resin particles is measured as follows. A particle size distribution measured by a laser diffraction particle size measurement apparatus (e.g., LA-700 manufactured by HORIBA Ltd.) is used and divided into different particle diameter ranges (channels), and a cumulative volume distribution computed from the small particle diameter side is determined. The particle diameter at which the cumulative frequency is 50% is measured as the volume average particle diameter D50v. The volume average diameters of particles in other dispersions are measured in the same manner.

The content of the resin particles contained in the resin particle dispersion is preferably from 5% by mass to 50% by mass inclusive and more preferably from 10% by mass to 40% by mass inclusive.

For example, the coloring agent particle dispersion and the release agent particle dispersion are prepared in a similar manner to the resin particle dispersion. Specifically, the descriptions of the volume average diameter of the particles in the resin particle dispersion, the dispersion medium for the resin particle dispersion, the dispersing method, and the content of the resin particles are applicable to the coloring agent particles dispersed in the coloring agent particle dispersion and the release agent particles dispersed in the release agent particle dispersion.

### —Aggregated Particle Forming Step—

Next, the resin particle dispersion, the coloring agent particle dispersion, and the release agent particle dispersion are mixed.

Then the resin particles, the coloring agent particles, and the release agent particles are hetero-aggregated in the dispersion mixture to form aggregated particles containing the resin particles, the coloring agent particles, and the release agent particles and having diameters close to the diameters of target toner particles.

Specifically, for example, a flocculant is added to the dispersion mixture, and the pH of the dispersion mixture is adjusted to acidic (for example, a pH of from 2 to 5 inclusive). Then a dispersion stabilizer is optionally added, and the resulting mixture is heated to a temperature close to the glass transition temperature of the resin particles (specifically, for example, a temperature from the glass transition temperature of the resin particles—30° C. to the glass transition temperature—10° C. inclusive) to aggregate the particles dispersed in the dispersion mixture to thereby form aggregated particles. In the aggregated particle forming step, the flocculant may be added at room temperature (e.g., 25° C.) while the dispersion mixture is agitated, for example, in a rotary shearing-type homogenizer. Then the pH of the dispersion mixture is adjusted to acidic (e.g., a pH of from 2 to 5 inclusive), and the dispersion stabilizer is optionally added. Then the resulting mixture is heated.

Examples of the flocculant include a surfactant with a polarity opposite to the polarity of the surfactant contained in the dispersion mixture, inorganic metal salts, and divalent or higher polyvalent metal complexes. When a metal complex is used as the flocculant, the amount of the surfactant used can be small, and charging characteristics are improved.

An additive that forms a complex with a metal ion in the flocculant or a similar bond may be optionally used together with the flocculant. The additive used may be a chelating agent.

Examples of the inorganic metal salts include: metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

The chelating agent used may be a water-soluble chelating agent. Examples of the chelating agent include: oxycarboxylic acids such as tartaric acid, citric acid, and gluconic acid; and amino carboxylic acids such as iminodiacetic acid (IDA), nitrilotriacetic acid (NTA), and ethylenediaminetetraacetic acid (EDTA).

The amount of the chelating agent added is preferably from 0.01 parts by mass to 5.0 parts by mass inclusive and more preferably 0.1 parts by mass or more and less than 3.0 parts by mass based on 100 parts by mass of the resin particles.

### —Fusion/Coalescence Step—

Next, the aggregated particle dispersion in which the aggregated particles are dispersed is heated, for example, to a temperature equal to or higher than the glass transition temperature of the resin particles (e.g., a temperature higher by 10° C. to 30° C. than the glass transition temperature of the resin particles) to fuse and coalesce the aggregated particles to thereby form toner particles.

The toner particles are obtained through the above-described steps.

Alternatively, the toner particles may be produced through: the step of, after the preparation of the aggregated particle dispersion containing the aggregated particles dispersed therein, mixing the aggregated particle dispersion further with the resin particle dispersion containing the resin particles dispersed therein and then causing the resin particles to adhere to the surfaces of the aggregated particles to aggregate them to thereby form second aggregated particles; and the step of heating a second aggregated particle dispersion containing the second aggregated particles dispersed therein to fuse and coalesce the second aggregated particles to thereby form toner particles having the core-shell structure.

After completion of the fusion/coalescence step, the toner particles in the dispersion are subjected to a well-known washing step, a solid-liquid separation step, and a drying step to obtain dried toner particles. From the viewpoint of chargeability, the toner particles may be subjected to displacement washing with ion exchanged water sufficiently in the washing step. From the viewpoint of productivity, suction filtration, pressure filtration, etc. may be performed in the solid-liquid separation step. From the viewpoint of productivity, freeze-drying, flash drying, fluidized drying, vibrating fluidized drying, etc. may be performed in the drying step.

The toner according to the present exemplary embodiment is produced, for example, by adding the external additives to the dried toner particles obtained and mixing them. The mixing may be performed, for example, using a V blender, a Henschel mixer, a Loedige mixer, etc. If necessary, coarse particles in the toner may be removed using a vibrating sieving machine, an air sieving machine, etc.

### (Carrier B)

The electrostatic image developer according to the present exemplary embodiment includes the carrier B including the core material and the coating resin layer that covers the core material and contains inorganic particles.

No particular limitation is imposed on the method for controlling the surface roughness Ra of the carrier B. Examples of the method include: a method in which the surface roughness Ra of the core material is adjusted; a method in which the thickness of the coating resin layer is adjusted; and a method in which, when the carrier is produced, the rate of stirring a mixture of the resin forming the coating resin layer, the core material, the inorganic particles, and an optionally added solvent, the stirring speed, the stirring temperature, and the stirring time are adjusted.

### [Core Material]

The carrier B includes the core material.

No particular limitation is imposed on the core material so long as it has magnetism, and a well-known material used as a core material of a carrier may be used.

Examples of the core material include: particulate magnetic powders (magnetic particles); resin-impregnated magnetic particles obtained by impregnating a porous magnetic powder with a resin; and magnetic powder-dispersed resin particles obtained by dispersing a magnetic powder in a resin.

Examples of the magnetic powder include: particles of magnetic metals such as iron, nickel, and cobalt; and magnetic oxides such as ferrite and magnetite. The magnetic powder may be a magnetic oxide. One type of magnetic particles may be used alone, or a combination of two or more types may be used.

Examples of the resin forming the core material include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic acid copolymers, straight silicones having organosiloxane bonds and modified products thereof, fluorocarbon resins, polyesters, polycarbonates, phenolic resins, and epoxy resins. One of these resins may be used alone, or two or more of them may be used in combination. The resin forming the core material may contain an additive such as electrically conductive particles. Examples of the electrically conductive particles include: particles of metals such as gold, silver, and copper; and particles of carbon black, titanium oxide, zinc oxide, tin oxide, barium sulfate, aluminum borate, and potassium titanate.

The core material may be a particulate magnetic powder, i.e., magnetic particles.

The surface roughness Ra of the core material is preferably from 0.5 μm to 1.5 μm inclusive, more preferably from 0.6 μm to 1.2 μm inclusive, and still more preferably from 0.7 μm to 1.0 μm inclusive.

No particular limitation is imposed on the method for adjusting the surface roughness Ra of the core material within the above range. Examples of the method include a method in which the core material is produced using a wet ball mill and the particle size of the raw material of the core material or the size of particles obtained by pulverizing the sintered product of the raw material is adjusted.

The volume average diameter of the magnetic particles may be, for example, from 20 μm to 50 μm inclusive.

### [Coating Resin Layer]

The coating resin layer contains the inorganic particles.

The coating resin layer is a resin layer that covers the core material.

In the coating resin layer, the volume average diameter D (μm) of the inorganic particles and the thickness T (μm) of the coating resin layer satisfy relational expression (1) below. From the viewpoint of preventing density unevenness in images more effectively, the volume average diameter D (μm) and the thickness T (μm) satisfy preferably relational expression (1-2) below and more preferably relational expression (1-3).

0.007≤D/T≤0.24 Relational expression (1)

0.007≤D/T≤0.2 Relational expression (1-2)

0.007≤D/T≤0.05 Relational expression (1-3)

No particular limitation is imposed on the method for forming the coating resin layer that satisfies the above relational expression (1), (1-2), or (1-3). Examples of the method include: a method in which the type of resin forming the coating resin layer is adjusted; and a method in which the diameter of the inorganic particles is adjusted.

### —Resin—

Examples of the resin forming the coating resin layer include: styrene-acrylic acid copolymers; polyolefin resins such as polyethylene and polypropylene; polyvinyl and polyvinylidene resins such as polystyrene, acrylic resins, polyacrylonitrile, polyvinyl acetate, polyvinyl alcohol, polyvinyl butyral, polyvinyl chloride, polyvinylcarbazole, polyvinyl ether, and polyvinyl ketone; vinyl chloride-vinyl acetate copolymers; straight silicone resins having organosiloxane bonds and modified products thereof; fluorocarbon resins such as polytetrafluoroethylene, polyvinyl fluoride, polyvinylidene fluoride, and polychlorotrifluoroethylene; polyesters; polyurethanes; polycarbonates; amino resins such as urea-formaldehyde resins; and epoxy resins.

The coating resin layer may contain an alicyclic (meth)acrylic resin. When the coating resin layer contains an alicyclic (meth)acrylic resin, the dispersibility of the inorganic particles contained in the coating resin layer tends to be high, and resin pieces containing the inorganic particles tend to be generated efficiently. Therefore, density unevenness in images tends to be preventing more effectively.

The monomer component of the alicyclic (meth)acrylic resin may be a lower alkyl ester of (meth)acrylic acid (e.g., an alkyl (meth)acrylate in which the number of carbon atoms in the alkyl group is from 1 to 9 inclusive). Specific examples include methyl (meth)acrylate, ethyl (meth)acrylate, propyl (meth)acrylate, butyl (meth)acrylate, hexyl (meth)acrylate, cyclohexyl (meth)acrylate, 2-ethylhexyl (meth)acrylate, and 2-(dimethylamino)ethyl (meth)acrylate.

In particular, from the viewpoint of preventing density unevenness in images more effectively, the alicyclic (meth)acrylic resin contains, as the monomer component, preferably at least one selected from the group consisting of methyl (meth)acrylate, cyclohexyl (meth)acrylate, and 2-(dimethylamino)ethyl (meth)acrylate and more preferably at least one of methyl (meth)acrylate and cyclohexyl (meth)acrylate. One monomer component may be used for the alicyclic (meth)acrylic resin, or a combination of two or more may be used.

The alicyclic (meth)acrylic resin blocks the influence of water on a polarization component of the bond between carbon and oxygen atoms through the steric hindrance of the alicyclic functional group. The alicyclic (meth)acrylic resin may contain cyclohexyl (meth)acrylate as the monomer component because the influence of water when an environmental change occurs can be reduced.

The content of cyclohexyl (meth)acrylate contained in the alicyclic (meth)acrylic resin is preferably from 75% by mole to 100% by mole inclusive, more preferably from 90% by mole to 100% by mole inclusive, and still more preferably from 95% by mole to 100% by mole inclusive.

The ratio of the mass of the alicyclic (meth)acrylic resin to the total mass of the resins contained in the coating resin layer is preferably 80% by mass or more, more preferably 90% by mass or more, and still more preferably 95% by mass or more.

### —Inorganic Particles—

Examples of the inorganic particles include particles of silica, alumina, titanium oxide (titania), barium titanate, magnesium titanate, calcium titanate, strontium titanate, iron oxide, copper oxide, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. In particular, from the viewpoint of preventing density unevenness in images more effectively, the inorganic particles include preferably particles of at least one selected from the group consisting of silica, alumina, strontium titanate, calcium titanate, barium titanate, and titanium oxide and include more preferably silica particles.

The inorganic particles include preferably inorganic particles subjected to hydrophobization treatment with a hydrophobizing agent and more preferably silica particles subjected to hydrophobization treatment.

The hydrophobizing agent may be any well-known surface treatment agent, and specific examples include silane coupling agents and silicone oils.

Examples of the silane coupling agent include: hexamethyldisilazane, trimethylsilane, trimethylchlorosilane, dimethyldichlorosilane, methyltrichlorosilane, allyldimethylchlorosilane, benzyldimethylchlorosilane, methyltrimethoxysilane, methyltriethoxysilane, isobutyltrimethoxysilane, dimethyldimethoxysilane, dimethyldiethoxysilane, trimethylmethoxysilane, hydroxypropyltrimethoxysilane, phenyltrimethoxysilane, n-butyltrimethoxysilane, n-hexadecyltrimethoxysilane, n-octadecyltrimethoxysilane, vinyltrimethoxysilane, vinyltriethoxysilane, 7-methacryloxypropyltrimethoxysilane, and vinyltriacetoxysilane.

Examples of the silicone oil include dimethylpolysiloxane, methylhydrogenpolysiloxane, and methylphenylpolysiloxane.

In particular, the hydrophobizing agent contains preferably at least one of hexamethyldisilazane (HMDS) and dimethylpolysiloxane (PDMS) and more preferably HMDS.

From the viewpoint of the image unevenness prevention ability, the volume average diameter D of the inorganic particles is preferably from 1 nm to 100 nm inclusive, more preferably from 5 nm to 90 nm inclusive, still more preferably from 5 nm to 50 nm inclusive, and particularly preferably from 5 nm to 30 nm inclusive.

The volume average diameter D of the inorganic particles is determined by observing the surface of the carrier under a scanning electron microscope and subjecting images of inorganic particles adhering to the coating resin layer to image analysis. Specifically, 50 inorganic particles per carrier particle are observed under the scanning electron microscope. Image analysis is performed to measure the maximum and minimum diameters of each of the inorganic particles, and the equivalent spherical diameter is determined from the intermediate value of the maximum and minimum diameters. The measurement of the equivalent spherical diameter is performed on 100 carrier particles. Then the 50% diameter (D50v) in a volume-based cumulative frequency distribution of the equivalent spherical diameters obtained is used as the volume average diameter D of the inorganic particles.

From the viewpoint of the image unevenness prevention ability, the content of the inorganic particles is preferably from 3% by mass to 70% by mass inclusive, more preferably from 10% by mass to 60% by mass inclusive, still more preferably from 10% by mass to 50% by mass inclusive, and particularly preferably from 20% by mass to 40% by mass inclusive, based on the total mass of the coating resin layer.

### —Elemental Nitrogen-Containing Resin Particles—

From the viewpoint of the image unevenness prevention ability, the coating resin layer may further contain elemental nitrogen-containing resin particles.

Examples of the elemental nitrogen-containing resin particles include: particles of (meth)acrylic-based resins prepared by polymerization of monomers including dimethylaminoethyl (meth)acrylate, dimethylacrylamide, acrylonitrile, etc.; particles of amino resins such as urea, melamine, guanamine, and aniline; particles of amide resins; particles of urethane resins; and particles of copolymers of the above resins. In particular, from the viewpoint of the image unevenness prevention ability, the elemental nitrogen-containing resin particles include preferably at least one type of particles selected from the group consisting of amino resin particles and urethane resin particles, include more preferably amino resin particles, and include still more preferably melamine resin particles. Only one type of nitrogen-containing resin particles may be used alone, or a combination of two or more types may be used.

From the viewpoint of the image unevenness prevention ability, the content of the elemental nitrogen-containing resin particles is preferably from 5% by mass to 30% by mass inclusive, more preferably from 6% by mass to 20% by mass inclusive, and still more preferably from 8% by mass to 15% by mass inclusive, based on the total mass of the coating resin layer.

From the viewpoint of the image unevenness prevention ability, the content of the elemental nitrogen-containing resin particles in the present exemplary embodiment is preferably from 15% by mass to 55% by mass inclusive, more preferably from 20% by mass to 45% by mass inclusive, and still more preferably from 25% by mass to 40% by mass inclusive, based on the total mass of the inorganic particles.

From the viewpoint of more effectively preventing hollow defects in images, the volume average particle diameter of the elemental nitrogen-containing resin particles in the present exemplary embodiment is preferably from 100 nm to 500 nm inclusive, more preferably from 120 nm to 400 nm inclusive, and still more preferably from 150 nm to 300 nm inclusive. In particular, when the volume average particle diameter of the elemental nitrogen-containing resin particles is 100 nm or more, irregularities can be easily formed on the surface of the carrier, so that the external additives for the toner tend to be physically prevented from adhering to the carrier.

The volume average particle diameter of the elemental nitrogen-containing resin particles can be determined by the same method as that for the volume average particle diameter of the inorganic particles.

Examples of the method for forming the coating resin layer on the core material surface include a wet production method and a dry production method. The wet production method uses a solvent that can dissolve or disperse the resin forming the coating resin layer. The dry production method does not use the solvent.

Examples of the wet production method include: an immersion method in which the core material is immersed in a resin solution for forming the coating resin layer to thereby coat the core material with the resin; a spray method in which the resin solution for forming the coating resin layer is sprayed onto the surface of the core material; a fluidized bed method in which the resin solution for forming the coating resin layer is sprayed onto the core material floating in a fluidized bed; and a kneader-coater method in which the core material and the resin solution for forming the coating resin layer are mixed in a kneader coater and then the solvent is removed.

The resin solution for forming the coating resin layer used in the wet production method is prepared by dissolving or dispersing the resin and an additional component in the solvent. No particular limitation is imposed on the solvent, so long as it can dissolve or disperse the resin. Examples of the solvent include: aromatic hydrocarbons such as toluene and xylene; ketones such as acetone and methyl ethyl ketone; and ethers such as tetrahydrofuran and dioxane.

Examples of the dry production method include a method in which a dry mixture of the core material and the resin for forming the coating resin layer is heated to form the coating resin layer. Specifically, for example, the core material and the resin for forming the coating resin layer are mixed in air and heat-fused to form the coating resin layer.

The thickness T (km) of the coating resin layer is preferably from 0.1 μm to 10 μm inclusive, more preferably from 0.2 μm to 5 μm inclusive, and still more preferably from 0.3 μm to 3 μm inclusive.

The thickness T of the coating resin layer is measured by the following method. The carrier is embedded in, for example, an epoxy resin and cut with, for example, a diamond knife to thereby produce a thin slice. The thin slice is observed under, for example, a transmission electron macroscope (TEM), and cross-sectional images of a plurality of carrier particles are taken. The thickness of the coating resin layer is measured at 20 points in the cross-sectional images of the carrier particles, and the average of the measured values is used.

The electrostatic image developer according to the present exemplary embodiment is prepared by mixing the toner A and the carrier B at an appropriate mixing ratio. The mixing ratio (mass ratio) of the toner A to the carrier B is preferably toner:carrier=1:100 to 20:100 and more preferably 3:100 to 14:100.

### <Image Forming Apparatus and Image Forming Method>

An image forming apparatus and an image forming method according to the present exemplary embodiment will be described.

The image forming apparatus in the present exemplary embodiment includes: an image holding member; a charging device that charges the surface of the image holding member; an electrostatic image forming device that forms an electrostatic image on the charged surface of the image holding member; a developing device that houses an electrostatic image developer and develops the electrostatic image formed on the surface of the image holding member with the electrostatic image developer to thereby form a toner image; a transferring device that transfers the toner image formed on the surface of the image holding member onto a surface of a recording medium; and a fixing device that fixes the toner image transferred onto the surface of the recording medium. The electrostatic image developer used is the electrostatic image developer according to the present exemplary embodiment.

In the image forming apparatus in the present exemplary embodiment, an image forming method (an image forming method in the present exemplary embodiment) is performed. The image forming method includes: charging the surface of the image holding member; forming an electrostatic image on the charged surface of the image holding member; developing the electrostatic image formed on the surface of the image holding member with the electrostatic image developer according to the present exemplary embodiment to thereby form a toner image; transferring the toner image formed on the surface of the image holding member onto a surface of a recording medium; and fixing the toner image transferred onto the surface of the recording medium.

The image forming apparatus in the present exemplary embodiment may be applied to known image forming apparatuses such as: a direct transfer-type apparatus that transfers a toner image formed on the surface of the image holding member directly onto a recording medium; an intermediate transfer-type apparatus that first-transfers a toner image formed on the surface of the image holding member onto the surface of an intermediate transfer body and second-transfers the toner image transferred onto the surface of the intermediate transfer body onto the surface of a recording medium; an apparatus including a cleaning device that cleans the surface of the image holding member after the transfer of the toner image but before charging; and an apparatus including a charge eliminating device that eliminates charges on the surface of the image holding member after transfer of the toner image but before charging by irradiating the surface of the image holding member with charge eliminating light.

When the image forming apparatus in the present exemplary embodiment is the intermediate transfer-type apparatus, the transferring device includes, for example: an intermediate transfer body having a surface onto which a toner image is to be transferred; a first transferring device that first-transfers a toner image formed on the surface of the image holding member onto the surface of the intermediate transfer body; and a second transferring device that second-transfers the toner image transferred onto the surface of the intermediate transfer body onto the surface of a recording medium.

In the image forming apparatus in the present exemplary embodiment, for example, a portion including the developing device may have a cartridge structure (process cartridge) that is detachably attached to the image forming apparatus. The process cartridge used may be, for example, a process cartridge including the developing device that houses the electrostatic image developer according to the present exemplary embodiment.

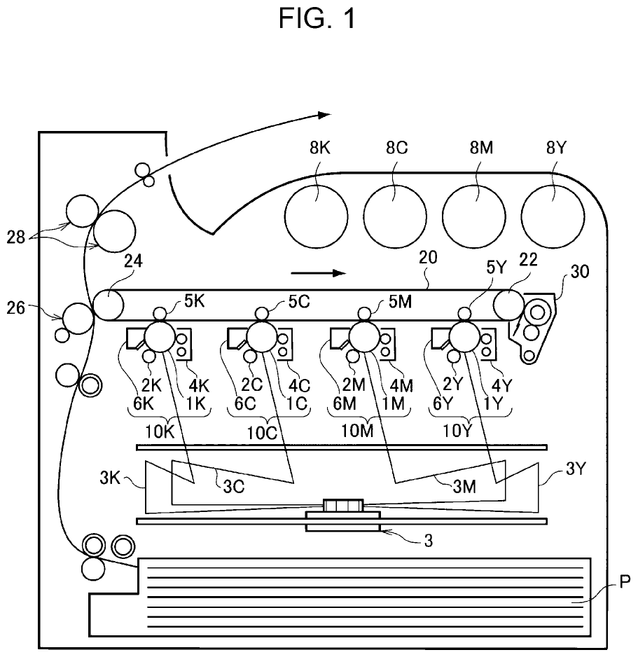

An example of the image forming apparatus in the present exemplary embodiment will be described, but this is not a limitation. In the following description, major components shown in FIG. 1 will be described, and description of other components will be omitted.

FIG. 1 is a schematic configuration diagram showing the image forming apparatus in the present exemplary embodiment.

The image forming apparatus shown in FIG. 1 includes first to fourth electrophotographic image forming units 10Y, 10M, 10C, and 10K (image forming devices) that output yellow (Y), magenta (M), cyan (C), and black (K) images, respectively, based on color-separated image data. These image forming units (hereinafter may be referred to simply as “units”) 10Y, 10M, 10C, and 10K are arranged so as to be spaced apart from each other horizontally by a prescribed distance. These units 10Y, 10M, 10C, and 10K may each be a process cartridge detachably attached to the image forming apparatus.

An intermediate transfer belt (an example of the intermediate transfer body) 20 is disposed above the units 10Y, 10M, 10C, and 10K so as to extend through these units. The intermediate transfer belt 20 is wound around a driving roller 22 and a support roller 24 and runs in a direction from the first unit 10Y toward the fourth unit 10K. A force is applied to the support roller 24 by, for example, an unillustrated spring in a direction away from the driving roller 22, so that a tension is applied to the intermediate transfer belt 20 wound around the rollers. An intermediate transfer body cleaner 30 is disposed on an image holding member-side of the intermediate transfer belt 20 so as to be opposed to the driving roller 22.

Yellow, magenta, cyan, and black toners contained in toner cartridges 8Y, 8M, 8C, and 8K, respectively, are supplied to developing units (examples of the developing device) 4Y, 4M, 4C, and 4K, respectively, of the units 10Y, 10M, 10C, and 10K.

The first to fourth units 10Y, 10M, 10C, and 10K have the same structure and operate similarly. Therefore, the first unit 10Y that is disposed upstream in the running direction of the intermediate transfer belt and forms a yellow image will be described as a representative unit.

The first unit 10Y includes a photoconductor 1Y serving as an image holding member. A charging roller (an example of the charging device) 2Y, an exposure unit (an example of the electrostatic image forming device) 3, a developing unit (an example of the developing device) 4Y, a first transfer roller 5Y (an example of the first transferring device), and a photoconductor cleaner (an example of the cleaning device) 6Y are disposed around the photoconductor 1Y in this order. The charging roller charges the surface of the photoconductor 1Y to a prescribed potential, and the exposure unit 3 exposes the charged surface to a laser beam 3Y according to a color-separated image signal to thereby form an electrostatic image. The developing unit 4Y supplies a charged toner to the electrostatic image to develop the electrostatic image, and the first transfer roller 5Y transfers the developed toner image onto the intermediate transfer belt 20. The photoconductor cleaner 6Y removes the toner remaining on the surface of the photoconductor 1Y after the first transfer.

The first transfer roller 5Y is disposed on the inner side of the intermediate transfer belt 20 and placed at a position opposed to the photoconductor 1Y. Bias power sources (not shown) for applying a first transfer bias are connected to the respective first transfer rollers 5Y, 5M, 5C, and 5K of the units. The bias power sources are controlled by an unillustrated controller to change the values of transfer biases applied to the respective first transfer rollers.

A yellow image formation operation in the first unit 10Y will be described.

First, before the operation, the surface of the photoconductor 1Y is charged by the charging roller 2Y to a potential of −600 V to −800 V.

The photoconductor 1Y is formed by stacking a photosensitive layer on a conductive substrate (with a volume resistivity of, for example, 1×10⁻⁶ Ωcm or less at 20° C.). The photosensitive layer generally has a high resistance (the resistance of a general resin) but has the property that, when irradiated with a laser beam, the specific resistance of a portion irradiated with the laser beam is changed. Therefore, the charged surface of the photoconductor 1Y is irradiated with a laser beam 3Y from the exposure unit 3 according to yellow image data sent from an unillustrated controller. An electrostatic image with a yellow image pattern is thereby formed on the surface of the photoconductor 1Y.

The electrostatic image is an image formed on the surface of the photoconductor 1Y by charging and is a negative latent image formed as follows. The specific resistance of the irradiated portions of the photosensitive layer irradiated with the laser beam 3Y decreases, and this causes charges on the surface of the photoconductor 1Y to flow. However, the charges in portions not irradiated with the laser beam 3Y remain present, and the electrostatic image is thereby formed.

The electrostatic image formed on the photoconductor 1Y rotates to a prescribed developing position as the photoconductor 1Y rotates. Then the electrostatic image on the photoconductor 1Y at the developing position is developed and visualized as a toner image by the developing unit 4Y.

An electrostatic image developer containing, for example, at least a yellow toner and a carrier is contained in the developing unit 4Y. The yellow toner is agitated in the developing unit 4Y and thereby frictionally charged. The charged yellow toner has a charge with the same polarity (negative polarity) as the charge on the photoconductor 1Y and is held on a developer roller (an example of a developer holding member). As the surface of the photoconductor 1Y passes through the developing unit 4Y, the yellow toner electrostatically adheres to charge-eliminated latent image portions on the surface of the photoconductor 1Y, and the latent image is thereby developed with the yellow toner. Then the photoconductor 1Y with the yellow toner image formed thereon continues running at a prescribed speed, and the toner image developed on the photoconductor 1Y is transported to a prescribed first transfer position.

When the yellow toner image on the photoconductor 1Y is transported to the first transfer position, a first transfer bias is applied to the first transfer roller 5Y, and an electrostatic force directed from the photoconductor 1Y toward the first transfer roller 5Y acts on the toner image, so that the toner image on the photoconductor 1Y is transferred onto the intermediate transfer belt 20. The transfer bias applied in this case has a (+) polarity opposite to the (−) polarity of the toner and is controlled to, for example, +10 μA in the first unit 10Y by the controller (not shown).

The toner remaining on the photoconductor 1Y is removed and collected by the photoconductor cleaner 6Y.

The first transfer biases applied to the first transfer rollers 5M, 5C, and 5K of the second unit 10M and subsequent units are controlled in the same manner as in the first unit.

The intermediate transfer belt 20 with the yellow toner image transferred thereon in the first unit 10Y is sequentially transported through the second to fourth units 10M, 10C and 10K, and toner images of respective colors are superimposed and multi-transferred.

Then the intermediate transfer belt 20 with the four color toner images multi-transferred thereon in the first to fourth units reaches a second transfer portion that is composed of the intermediate transfer belt 20, the support roller 24 in contact with the inner surface of the intermediate transfer belt, and a second transfer roller (an example of the second transferring device) 26 disposed on the image holding surface side of the intermediate transfer belt 20. A recording paper sheet (an example of the recording medium) P is supplied to a gap between the second transfer roller 26 and the intermediate transfer belt 20 in contact with each other at a prescribed timing through a supply mechanism, and a second transfer bias is applied to the support roller 24. The transfer bias applied in this case has the same polarity (−) as the polarity (−) of the toner, and an electrostatic force directed from the intermediate transfer belt 20 toward the recording paper sheet P acts on the toner image, so that the toner image on the intermediate transfer belt 20 is transferred onto the recording paper sheet P. In this case, the second transfer bias is determined according to a resistance detected by a resistance detection device (not shown) that detects the resistance of the second transfer portion and is voltage-controlled.

Then the recording paper sheet P is transported to a press contact portion (nip portion) of a pair of fixing rollers in a fixing unit (an example of the fixing device) 28, and the toner image is fixed onto the recording paper sheet P to thereby form a fixed image.

Examples of the recording paper sheet P onto which a toner image is to be transferred include plain paper sheets used for electrophotographic copying machines, printers, etc. Examples of the recording medium include, in addition to the recording paper sheets P, transparencies.

To further improve the smoothness of the surface of a fixed image, it may be necessary that the surface of the recording paper sheet P be smooth. For example, coated paper prepared by coating the surface of plain paper with, for example, a resin, art paper for printing, etc. are suitably used.

The recording paper sheet P with the color image fixed thereon is transported to an ejection portion, and a series of the color image formation operations is thereby completed.

### <Process Cartridge and Toner Cartridge>

A process cartridge in the present exemplary embodiment will be described.

The process cartridge according to the present exemplary embodiment includes a developing device that houses the electrostatic image developer according to the present exemplary embodiment and develops an electrostatic image formed on the surface of an image holding member with the electrostatic image developer to thereby form a toner image. The process cartridge is detachably attached to the image forming apparatus.

The structure of the process cartridge according to the present exemplary embodiment is not limited to the above-described structure and may include the developing device and at least one optional device selected from other devices such as an image holding member, a charging device, an electrostatic image forming device, and a transferring device.

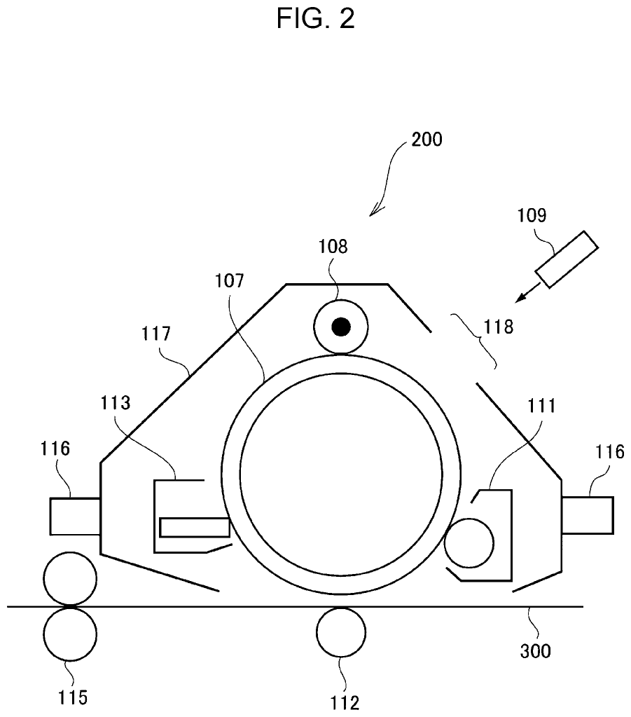

An example of the process cartridge according to the present exemplary embodiment will be described, but this is not a limitation. In the following description, major components shown in FIG. 2 will be described, and description of other components will be omitted.

FIG. 2 is a schematic configuration diagram showing the process cartridge according to the present exemplary embodiment.

The process cartridge 200 shown in FIG. 2 includes, for example, a housing 117 including mounting rails 116 and an opening 118 for light exposure and further includes a photoconductor 107 (an example of the image holding member), a charging roller 108 (an example of the charging device) disposed on the circumferential surface of the photoconductor 107, a developing unit 111 (an example of the developing device), and a photoconductor cleaner 113 (an example of the cleaning device), which are integrally combined and held in the housing 117 to thereby form a cartridge.

In FIG. 2, 109 denotes an exposure unit (an example of the electrostatic image forming device), and 112 denotes a transferring unit (an example of the transferring device). 115 denotes a fixing unit (an example of the fixing device), and 300 denotes a recording paper sheet (an example of the recording medium).

Next, a toner cartridge according to the present exemplary embodiment will be described.

The toner cartridge according to the present exemplary embodiment contains a toner in the present exemplary embodiment and is detachably attached to an image forming apparatus. The toner cartridge contains a replenishment toner to be supplied to a developing device disposed in the image forming apparatus.

The image forming apparatus shown in FIG. 1 has a structure in which the toner cartridges 8Y, 8M, 8C, and 8K are detachably attached, and the developing units 4Y, 4M, 4C, and 4K are connected to the respective toner cartridges (with respective colors) through unillustrated toner supply tubes. When the amount of the toner contained in a toner cartridge is reduced, this toner cartridge is replaced.

### EXAMPLES

The exemplary embodiment of the disclosure will be described in detail by way of Examples. However, the exemplary embodiment of the disclosure is not limited to these Examples.

In the following description, “parts” and “%” are based on mass, unless otherwise specified.

Synthesis, treatment, production, etc. are performed at room temperature (25° C.±3° C.), unless otherwise specified.

### <Preparation of Particle Dispersions>

### [Preparation of Amorphous Polyester Resin Particle Dispersion (1-1)]

Terephthalic acid: 30 parts by mole
Fumaric acid: 70 parts by mole
Ethylene oxide adduct of bisphenol A: 5 parts by mole
Propylene oxide adduct of bisphenol A: 95 parts by mole

The above materials are placed in a flask equipped with a stirrer, a nitrogen introduction tube, a temperature sensor, and a rectifying column. The temperature of the mixture is increased to 220° C. over 1 hour, and 1 part of titanium tetraethoxide is added to 100 parts of the above materials. While water produced is removed by evaporation, the temperature is increased to 230° C. over 0.5 hours. A dehydration condensation reaction is continued at 230° C. for 1 hour, and the reaction product is cooled. An amorphous polyester resin (1-1) having a weight average molecular weight of 18,000, an acid value of 15 mgKOH/g, and a glass transition temperature of 60° C. is thereby synthesized.

Next, a container equipped with a temperature controlling device and a nitrogen purging device is charged with 40 parts of ethyl acetate and 25 parts of 2-butanol to prepare a solvent mixture, and 100 parts of the amorphous polyester resin (1-1) is gradually added to the solvent mixture and dissolved therein. Then a 10% by mass aqueous ammonia solution is added thereto (in a molar amount corresponding to three times the acid value of the resin), and the mixture is stirred for 30 minutes.

Next, the container is purged with dry nitrogen. While the temperature is held at 40° C., 400 parts of ion exchanged water is added dropwise to the solution mixture under stirring at a rate of 2 parts/minute to emulsify the mixture. After completion of the dropwise addition, the temperature of the emulsion is returned to room temperature (20° C. to 25° C.), and dry nitrogen is bubbled for 48 hours under stirring to reduce the concentrations of ethyl acetate and 2-butanol to 1,000 ppm or less. A resin particle dispersion in which resin particles having a volume average particle diameter of 200 nm are dispersed is thereby obtained. Ion exchanged water is added to the resin particle dispersion to adjust the solid content to 20% by mass, and an amorphous polyester resin dispersion (1-1) is thereby obtained.

### [Preparation of Crystalline Polyester Resin Particle Dispersion (1-3))

1,10-Dodecanedioic acid: 50 parts by mole
1,9-Nonanediol: 50 parts by mole

The above monomer components are placed in a reaction vessel equipped with a stirrer, a thermometer, a condenser, and a nitrogen gas introduction tube, and the reaction vessel is purged with dry nitrogen gas. Then titanium tetrabutoxide (reagent) is added in an amount of 0.25 parts with respect to 100 parts of the monomer components. The mixture is allowed to react under stirring at 170° C. in a nitrogen gas flow for 3 hours. The resulting mixture is further heated to 210° C. over 1 hour, and the pressure inside the reaction vessel is reduced to 3 kPa. Then the mixture is allowed to react with stirring under reduced pressure for 13 hours, and a crystalline polyester resin (1-3) is thereby obtained.

Next, a jacketed 3 L reaction tank (BJ-30N manufactured by TOKYO RIKAKIKAI Co., Ltd.) equipped with a condenser, a thermometer, a water dropping unit, and an anchor blade is charged with 300 parts of the crystalline polyester resin (1-3), 160 parts of methyl ethyl ketone (solvent), and 100 parts of isopropyl alcohol (solvent). While the temperature of the mixture is maintained at 70° C. in a water-circulation thermostatic bath, the mixture is stirred at 100 rpm to thereby dissolve the resin (a solution preparing step).

Then the number of revolutions for stirring is changed to 150 rpm, and the temperature of the water-circulation thermostatic bath is set to 66° C. Then 17 parts of 10% ammonia water (reagent) is added over 10 minutes, and a total of 900 parts of ion exchanged water held at 66° C. is added dropwise at a rate of 7 parts/minute to perform phase inversion to thereby obtain an emulsion.

Immediately after the emulsification, 800 parts of the obtained emulsion and 700 parts of ion exchanged water are placed in a round bottom flask, and the round bottom flask is placed in an evaporator (TOKYO RIKAKIKAI Co., Ltd.) equipped with a vacuum control unit through a trap ball. The round bottom flask is heated in a hot water bath at 60° C. while rotated, and the pressure inside the flask is reduced to 7 kPa with attention given to bumping to remove the solvents. When the amount of the solvents collected has reached 1,100 parts, the pressure is returned to normal pressure, and the round bottom flask is water-cooled to thereby obtain a dispersion. The obtained dispersion has no solvent odor. The resin particles in the dispersion have a volume average particle diameter D50v of 130 nm. Then ion exchanged water is added to adjust the solid concentration to 20%, and the resulting dispersion is used as a crystalline polyester resin particle dispersion (1-3).

[Preparation of crystalline polyester resin particle dispersion (1-4)]

A crystalline polyester resin dispersion (1-4) is obtained using the same procedure as for (1-3) except that, instead of 1,9-nonanediol, 1,6-hexanediol is used for the crystalline polyester resin dispersion (1-4).

1,10-Dodecanedioic acid: 50 parts by mole
1,6-Hexanediol: 50 parts by mole

### [Preparation of Coloring Agent Particle Dispersion (1)]

Cyan pigment (Pigment Blue 15:3 manufactured by Dainichiseika Color & Chemicals Mfg. Co., Ltd.): 98 parts
Anionic surfactant (TaycaPower manufactured by Tayca Corporation): 2 parts
Ion exchanged water: 420 parts

The above materials are mixed and subjected to dispersion treatment using a homogenizer (IKA ULTRA-TURRAX) for 10 minutes to thereby obtain a coloring agent particle dispersion (1) having a volume average particle diameter of 164 nm and a solid content of 21.1%.

### [Preparation of Release Agent Particle Dispersion (1)]

Synthetic wax (FNP92 manufactured by Nippon Seiro Co., Ltd.): 50 parts
Anionic surfactant (TaycaPower manufactured by Tayca Corporation): 1 part
Ion exchanged water: 200 parts

The above materials are mixed, heated to 130° C., dispersed sufficiently using a homogenizer (ULTRA-TURRAX T50 manufactured by IKA), and then subjected to dispersion treatment using a pressure discharge-type homogenizer. When the volume average particle diameter has reached 200 nm, the product is collected, and a release agent particle dispersion (1) with a solid content of 20% is thereby obtained.

### <Production of Toner Particles>

### [Production of Toner Particles (1)]

Amorphous polyester resin particle dispersion (1-1): 169 parts
Crystalline polyester resin particle dispersion (1-3): 53 parts
Coloring agent particle dispersion (1): 33 parts
Release agent particle dispersion (1): 25 parts
Anionic surfactant (Dowfax 2A1 manufactured by Dow Chemical Company): 4.8 parts

The above materials with their temperature adjusted to 10° C. are placed in a cylindrical stainless steel container and subjected to dispersion treatment using a homogenizer (ULTRA-TURRAX T50 manufactured by IKA) for 2 minutes at 4000 rpm with a shearing force applied to the materials to thereby mix the materials. Next, 1.75 parts of a 10% aqueous nitric acid solution of aluminum sulfate used as a flocculant is gradually added dropwise, and the mixture is subjected to dispersion treatment for 10 minutes with the rotation speed of the homogenizer set to 10000 rpm to thereby obtain a raw material dispersion.

The raw material dispersion is transferred to a reaction vessel equipped with a mixing impeller having two paddles and a thermometer and heated to a solution temperature of 40° C. using a heating mantle under stirring at a rotation speed of 550 rpm. Then the pH of the raw material dispersion is adjusted in the range of from 2.2 to 3.5 using 0.3M nitric acid and a 1M aqueous sodium hydroxide solution, and the temperature and the pH are maintained for about 2 hours to allow aggregated particles to grow. Next, 21 parts of the amorphous polyester resin particle dispersion (1-1) is added, and the resulting mixture is held for 60 hours to allow the resin particles to adhere to the surfaces of the aggregated particles. Next, the solution temperature is increased to 53° C., and 21 parts of the amorphous polyester resin particle dispersion (1-1) is further added. The resulting mixture is held for 60 minutes to allow the resin particles to further adhere to the surfaces of the aggregated particles.

The aggregated particles are prepared while the size and shape of the particles are checked using an optical microscope and a particle diameter measurement device. Next, the pH is adjusted to 7.8 using a 5% aqueous sodium hydroxide solution, and the mixture is held for 15 minutes. Next, the pH is increased to 8.0 using a 5% aqueous sodium hydroxide solution, and then the solution temperature is increased to 85° C. An optical microscope is used to check whether the aggregated particles have been fused. The heating is stopped after 2 hours, and the mixture is cooled at a rate of 1.0° C./minute. A 20 μm mesh is used to perform solid-liquid separation, and the solids are repeatedly washed with water and dried using a vacuum dryer to thereby obtain toner particles (1). The volume average particle diameter of the toner particles (1) is 6.0 m.

### [Production of Toner Particles (2)]

Amorphous polyester resin particle dispersion (1-1): 425 parts
Crystalline polyester resin particle dispersion (1-4): 45 parts
Coloring agent particle dispersion (1): 20 parts
Release agent particle dispersion (1): 50 parts
Anionic surfactant (TaycaPower manufactured by Tayca Corporation): 30 parts

The above materials are placed in a stainless steel round flask. Then 0.1N(=mol/L) nitric acid is added to adjust the pH to 3.5, and 30 parts of an aqueous nitric acid solution with a poly-aluminum chloride concentration of 10% by mass is added. Then a homogenizer (ULTRA-TURRAX T50 manufactured by IKA) is used to disperse the particles at 30° C., and the mixture is heated to 43° C. in a heating oil bath and held for 30 minutes. Then 100 parts of the amorphous polyester resin particle dispersion (1-1) is gently added, and the resulting mixture is held for 1 hour. A 0.1N aqueous sodium hydroxide solution is added to adjust the pH to 8.5, and the resulting mixture is heated to 100° C. under continuous stirring and held for 10 hours. Then the mixture is cooled to 20° C. at a rate of 1° C./minute, filtrated, washed sufficiently with ion exchanged water, and dried to thereby obtain toner particles (2) with a volume average particle diameter of 4.5 m.

### <Production of Silica Particles (A)>

### [Preparation of Alkaline Catalyst Solution]

A glass-made reaction vessel equipped with a metallic stirring rod, a dropping nozzle, and a thermometer is charged with methanol and ammonia water with a concentration shown in Table 1 in amounts shown in Table 1, and the mixture is stirred to thereby obtain an alkaline catalyst solution.

### [Formation of Silica Base Particles by Sol-Gel Method]

The temperature of the alkaline catalyst solution is adjusted to 40° C., and the alkaline catalyst solution is purged with nitrogen. While the solution temperature of the alkaline catalyst solution is maintained at 40° C. under stirring, tetramethoxysilane (TMOS) in an amount shown in Table 1 and 124 parts of ammonia water with a catalyst (NH₃) concentration of 7.9% are simultaneously added dropwise to thereby obtain a silica base particle suspension.

### [Addition of Silane Coupling Agent]

While the solution temperature of the silica base particle suspension is maintained at 40° C. under stirring, methyltrimethoxysilane (MTMS) in an amount shown in Table 1 is added. After completion of the addition, the stirring is continued for 120 minutes to allow the MTMS to react, and at least part of the surfaces of the silica base particles are thereby coated with the reaction product of MTMS.

### [Addition of Molybdenum/Nitrogen-Containing Compound]

A molybdenum/nitrogen-containing compound in an amount shown in Table 1 is diluted with butanol to prepare an alcohol solution. This alcohol solution is added to the silica base particle suspension reacted with the silane coupling agent, and the resulting mixture is stirred for 100 minutes while the solution temperature is maintained at 30° C. The amount of the alcohol solution added is such that the number of parts of the molybdenum/nitrogen-containing compound with respect to 100 parts by mass of the solid in the silica base particle suspension is adjusted to an amount shown in Table 1.

“TP-415” in Table 1 is quaternary ammonium molybdate (Hodogaya Chemical Co., Ltd.).

### [Drying]

The suspension with the molybdenum/nitrogen-containing compound added thereto is transferred to a reaction bath for drying. While the suspension is stirred, liquid carbon dioxide is injected into the reaction bath. The temperature inside the reaction bath is increased to 150° C., and the pressure is increased to 15 MPa. While the temperature and the pressure are held to maintain the supercritical state of carbon dioxide, the stirring of the suspension is continued. Carbon dioxide is caused to flow into and out of the reaction bath at a flow rate of 5 L/minute to remove the solvent over 120 minutes, and silica particles (A) are thereby obtained. By adjusting the amounts of the ammonia water, the silane coupling agent, and the molybdenum/nitrogen-containing compound added, different silica particles (A) are produced.

### [X-Ray Fluorescence Analysis]

Silica particles (A) are subjected to X-ray fluorescence analysis using the measurement method described above to determine the Net intensity N_{Mo} of elemental molybdenum and the Net intensity N_{Si} of elemental silicon, and the Net intensity ratio N_{Mo}/N_{Si} is computed.

The average primary particle diameter of the silica particles (A) and the Net intensity ratio are shown in Table 1.

TABLE 1

| | Formation of silica | | | | | Molybdenum/nitrogen- | | Physical properties of | | |
|---|---|---|---|---|---|---|---|---|---|---|
| | base particles | | | | Surface | containing compound | | silica particles (A) | | |
| Silica | | Ammonia | Ammonia | | coating | | Amount | Average | | |
| particles (A) | Methanol | water | concentration | TMOS | MTMS | Material | added | primary | | N_{Mo}/ |
| Name | Parts by | Parts by | % by | Parts by | Parts by | name | Parts by | particle | N_{Mo} | N_{Si} |
| — | mass | mass | mass | mass | mass | — | mass | diameter nm | kcps | — |
| (A9) | 950 | 166 | 9.6 | 1000 | 10 | TP-415 | 0.5 | 61 | 6 | 0.030 |
| (A1) | 950 | 166 | 9.6 | 1000 | 22 | TP-415 | 1 | 61 | 8 | 0.035 |
| (A2) | 950 | 166 | 9.6 | 1000 | 30 | TP-415 | 4 | 61 | 22 | 0.10 |
| (A3) | 950 | 166 | 9.6 | 1000 | 50 | Ditetrakis(dibutyldibenzyl- | 5 | 62 | 31 | 0.18 |
| | | | | | | ammonium)molybdate | | | | |
| (A4) | 950 | 166 | 9.6 | 1000 | 170 | TP-415 | 20 | 62 | 58 | 0.25 |
| (A5) | 950 | 166 | 9.6 | 1000 | 180 | TP-415 | 30 | 62 | 65 | 0.30 |
| (A6) | 950 | 166 | 9.6 | 1000 | 190 | TP-415 | 45 | 62 | 74 | 0.35 |
| (A7) | 950 | 166 | 9.6 | 1000 | 230 | TP-415 | 50 | 62 | 86 | 0.40 |
| (A8) | 950 | 166 | 9.6 | 1000 | 240 | TP-415 | 50 | 62 | 94 | 0.45 |
| (A10) | 950 | 166 | 9.6 | 1000 | 250 | TP-415 | 50 | 62 | 97 | 0.50 |
| (A11) | 950 | 220 | 9.1 | 1000 | 50 | TP-415 | 4 | 80 | 24 | 0.12 |
| (A12) | 950 | 160 | 9.4 | 1000 | 175 | TP-415 | 25 | 50 | 59 | 0.25 |
| (A13) | 950 | 150 | 9.2 | 1000 | 180 | TP-415 | 30 | 40 | 60 | 0.25 |

### <Production of Toners>

100 Parts of toner particles shown in Table 2 and silica particles shown in Table 2 in an amount shown in Table 2 are mixed using a Henschel mixer and sieved using a vibrating sieve with a mesh size of 45 μm to obtain a toner.

TABLE 2

| | | Silica particles (A) | | | |
|---|---|---|---|---|---|
| | Toner | | | Average primary | Amount added |
| | particles | | N_{Mo}/ | particle | Parts based on |
| | Name | Name | N_{Si} | diameter Da | 100 parts of |
| | — | — | — | nm | toner particles |
| Toner (1) | (2) | (A1) | 0.035 | 61 | 0.8 |
| Toner (4) | (2) | (A4) | 0.25 | 62 | 0.8 |
| Toner (8) | (2) | (A8) | 0.45 | 62 | 0.8 |
| Toner A | (2) | (A4) | 0.25 | 62 | 0.5 |
| Toner B | (2) | (A4) | 0.25 | 62 | 3.0 |
| Toner D | (1) | (A4) | 0.25 | 62 | 0.6 |
| Toner (C1) | (2) | (A9) | 0.030 | 61 | 0.8 |
| Toner (C2) | (2) | (A10) | 0.50 | 62 | 0.8 |
| Toner (2) | (2) | (A2) | 0.10 | 61 | 0.8 |
| Toner (7) | (2) | (A7) | 0.40 | 62 | 0.8 |

### <Production of Carriers>

### [Preparation of Core Material]

—Ferrite particles (1)—

74 Parts of Fe₂O₃, 4 parts of Mg(OH)₂, and 21 parts of MnO₂ are mixed, and then the mixture is calcinated using a rotary kiln under the conditions of temperature: 950° C./7 hours (first calcination). The calcinated product is pulverized for 7 hours using a wet ball mill to adjust the average particle diameter to 2.0 m, and the pulverized product is granulated using a spray dryer. The granulated product is calcinated using a rotary kiln under the conditions of temperature: 950° C./6 hours (second calcination). The calcinated product is pulverized for 3 hours using a wet ball mill to adjust the average particle diameter to 5.6 m, and the pulverized product is granulated using a spray dryer. The granulated product is fired using an electric furnace under the conditions of temperature: 1300° C./5 hours. The fired product obtained is pulverized and classified to thereby obtain ferrite particles (1) having a volume average particle diameter of 32 m.

### [Preparation of Inorganic Particles]

Silica particles and alumina particles used are materials shown below.

—Silica Particles
Hydrophobizing agent: hexamethyldisilazane,
Volume average particle diameter D: 7 nm
Product number HM30S manufactured by Tokuyama Corporation

—Alumina Particles
Hydrophobizing agent: decylsilane
Volume average particle diameter D: 13 nm
Product number C805 manufactured by Nippon Aerosil Co., Ltd.

### <Production of Carrier (1)>

Ferrite particles (1): 100 parts
Silica particles (HM30S manufactured by Tokuyama Corporation): 0.9 parts
Melamine resin particles (EPOSTAR S manufactured by NIPPON SHOKUBAI Co., Ltd., average particle diameter; 200 nm): 0.3 parts
Carbon black: 0.15 parts
Cyclohexyl methacrylate/2-(dimethylamino)ethyl methacrylate copolymer (copolymerization ratio: 97.5 moles:2.5 moles):1.8 parts
Toluene: 14 parts

Among the above materials, the silica particles, the cyclohexyl methacrylate/2-(dimethylamino)ethyl methacrylate copolymer, and toluene, together with glass beads (diameter: 1 mm, the same amount as the amount of toluene), are placed in a sand mill (manufactured by Kansai Paint Co., Ltd.) and stirred at a rotation speed of 1200 rpm for 30 minutes to obtain a resin layer-forming solution (1). The ferrite particles (1) are placed in a vacuum degassed-type kneader, and then the resin layer-forming solution (1) is placed in the kneader. The pressure inside the kneader is reduced, and the temperature thereinside is increased under stirring to remove toluene by evaporation. The ferrite particles (1) are thereby coated with the resin. Then fine powders and coarse powders are removed using an Elbow-Jet to thereby obtain a carrier (1). The properties of the carrier (1) are shown in Table 3.

### <Production of Carriers (2) to (8)>

Carriers are produced using the same procedure as for the carrier (1) except that the amount of the resin (the copolymer), the type and amount of inorganic particles, and the type and amount of melamine resin particles are changed as shown in Table 3.

TABLE 3

| | | | Amount of | Amount of |
|---|---|---|---|---|
| | Amount of | Type of | inorganic | melamine resin |
| | resin added | inorganic | particles added | particles added |
| | [parts] | particles | [parts] | [parts] |
| Carrier (1) | 1.8 | Silica | 0.9 | 0.3 |
| Carrier (2) | 1.2 | Silica | 1.5 | 0.3 |
| Carrier (3) | 2.4 | Silica | 0.3 | 0.3 |
| Carrier (4) | 2.2 | — | 0 | 0.3 |
| Carrier (5) | 2.1 | Silica | 1.5 | 0 |
| Carrier (6) | 1.5 | Alumina | 1.5 | 0.3 |
| Carrier (7) | 1.8 | Silica | 1.2 | 0.3 |
| Carrier (8) | 2.4 | Silica | 0.25 | 0.3 |

### Examples 1 to 18 and Comparative Examples 1 to 3

### <Production of Electrostatic Image Developers>

8 Parts of a toner shown in Table 4 and 100 parts of a carrier shown in Table 4 are placed in a V blender, stirred, and sieved using a sieve with a mesh size of 212 μm to obtain an electrostatic image developer.

### <Evaluation of Image Unevenness Prevention Ability>

One of the obtained cyan electrostatic image developers is filled into a developing unit of DocuCentre Color 400 manufactured by FUJIFILM Business Innovation Corp. An image chart with an area coverage of 20% (area coverage: the ratio of an area coated with the toner in the image) is printed on 1000 A4 size sheets (J paper manufactured by FUJIFILM Business Innovation Corp.) in an environment of 28° C. and 85% RH, and then an image chart with an area coverage of 1% is printed on 500 sheets. This procedure is repeated. After printing on 30000 sheets, splattering of the toner is evaluated in image portions on the last 5 outputted sheets.

“Density E” is a value obtained by subtracting the density of a blank paper sheet not used for the test from the average of nine density measurements in a non-image portion measured using an image density meter (X-Rite 938 manufactured by X-Rite).

Splattering after printing is evaluated. A to C are permissible.
A: Even when the image is observed under a loupe, no splattering is observed in a background portion (i.e., a non-image portion) of the image, and the image is of good quality (the density E is less than 0.015).
B: When the image is observed under the loupe, slight splattering is found on the image (0.15 or more and less than 0.030), but the image is of good quality without any problems.
C: When the image is observed under the loupe, splattering is found on the image (the density E is 0.030 or more and less than 0.040), but the image has no problems.
D: Slight splattering is found by visual inspection (the density E is 0.040 or more and less than 0.050), and the level of splattering is not permissible.
E: Splattering is found by visual inspection (the density E is 0.050 or more), and the level of splattering is not permissible.

TABLE 4

| | | | Surface | Content of inorganic | Surface | | Image |
|---|---|---|---|---|---|---|---|
| | | | coverage Ca | particles in coating | coverage Cb | | unevenness |
| | | | of toner | resin layer (% by | of carrier | | prevention |
| | Carrier | Toner | (area %) | mass) | (area %) | Ca/Cb | ability |
| Example 1 | Carrier (1) | Toner (4) | 15 | 30 | 30 | 0.50 | A |
| Example 2 | Carrier (1) | Toner (1) | 15 | 30 | 30 | 0.50 | A |
| Example 3 | Carrier (1) | Toner (8) | 15 | 30 | 30 | 0.50 | A |
| Example 4 | Carrier (2) | Toner (4) | 15 | 50 | 58 | 0.26 | A |
| Example 5 | Carrier (2) | Toner (1) | 15 | 50 | 58 | 0.26 | B |
| Example 6 | Carrier (2) | Toner (8) | 15 | 50 | 58 | 0.26 | B |
| Example 7 | Carrier (3) | Toner (4) | 15 | 10 | 12 | 1.25 | A |
| Example 8 | Carrier (3) | Toner (1) | 15 | 10 | 12 | 1.25 | B |
| Example 9 | Carrier (3) | Toner (8) | 15 | 10 | 12 | 1.25 | B |
| Example 10 | Carrier (1) | Toner A | 10 | 30 | 30 | 0.33 | A |
| Example 11 | Carrier (1) | Toner B | 57 | 30 | 30 | 1.90 | A |
| Example 11 | Carrier (1) | Toner D | 15 | 30 | 30 | 0.50 | A |
| Example 12 | Carrier (5) | Toner (1) | 15 | 30 | 12 | 1.25 | B |
| Example 13 | Carrier (6) | Toner (1) | 15 | 43 | 12 | 1.25 | B |
| Example 14 | Carrier (7) | Toner (1) | 15 | 52 | 63 | 0.24 | C |
| Example 15 | Carrier (8) | Toner (1) | 15 | 8 | 8 | 1.88 | C |
| Example 16 | Carrier (3) | Toner (2) | 15 | 10 | 12 | 1.25 | B |
| Example 17 | Carrier (3) | Toner (7) | 15 | 10 | 12 | 1.25 | B |
| Example 18 | Carrier (3) | Toner B | 57 | 10 | 12 | 4.75 | C |
| Comparative | Carrier (1) | Toner (C1) | 15 | 30 | 30 | 0.50 | D |
| Example 1 | | | | | | | |
| Comparative | Carrier (1) | Toner (C2) | 15 | 30 | 30 | 0.50 | D |
| Example 2 | | | | | | | |
| Comparative | Carrier (4) | Toner (4) | 15 | 0 | — | — | E |
| Example 3 | | | | | | | |

As can be seen from the above evaluation results, the electrostatic image developers in the Examples have a good image unevenness prevention ability.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An electrostatic image developer including: a toner A to which silica particles (A) containing an elemental nitrogen-containing compound containing elemental molybdenum are externally added; and a carrier B including a core material and a coating resin layer that covers the core material and contains inorganic particles, wherein, in the silica particles (A), the ratio N_{Mo}/N_{Si} of a Net intensity N_{Mo} of elemental molybdenum that is measured by X-ray fluorescence analysis to a Net intensity N_{Si} of elemental silicon that is measured by the X-ray fluorescence analysis is from 0.035 to 0.45 inclusive.
(((2))) The electrostatic image developer according to (((1))), wherein the content of the inorganic particles is from 10% by mass to 50% by mass inclusive based on the total mass of the coating resin layer.
(((3))) The electrostatic image developer according to (((1))) or (((2))), wherein a surface coverage Ca of toner particles in the toner A with the silica particles (A) is from 10% by area to 60% by area inclusive.
(((4))) The electrostatic image developer according to any one of (((1))) to (((3))), wherein a surface coverage Cb of the carrier B with the inorganic particles is from 10% by area to 60% by area inclusive.
(((5))) The electrostatic image developer according to any one of (((1))) to (((4))), wherein a surface coverage Ca of toner particles in the toner A with the silica particles (A) and a surface coverage Cb of the carrier B with the inorganic particles satisfy 0.2≤Ca/Cb≤3.
(((6))) The electrostatic image developer according to (((5))), wherein the surface coverage Ca of the toner particles in the toner A with the silica particles (A) and the surface coverage Cb of the carrier B with the inorganic particles satisfy 0.25≤Ca/Cb≤2.0.
(((7))) The electrostatic image developer according to any one of (((1))) to (((6))), wherein the inorganic particles are silica particles.
(((8))) The electrostatic image developer according to any one of (((1))) to (((7))), wherein the coating resin layer further contains elemental nitrogen-containing resin particles.
(((9))) A process cartridge detachably attached to an image forming apparatus, the process cartridge including a developing device that houses the electrostatic image developer according to any one of (((1))) to (((8))) and develops, as a toner image, an electrostatic image formed on a surface of an image holding member with the electrostatic image developer.
(((10))) An image forming apparatus including: an image holding member; a charging device that charges the image holding member; an exposure device that exposes the charged image holding member to light to thereby form an electrostatic latent image on the image holding member; a developing device that develops the electrostatic latent image with an electrostatic image developer to thereby form a toner image; a transferring device that transfers the toner image from the image holding member onto a transfer medium; and a fixing device that fixes the toner image, wherein the electrostatic image developer is the electrostatic image developer according to any one of (((1))) to (((8))).
(((11))) An image forming method including: charging at least an image holding member; exposing the charged image holding member to light to thereby form an electrostatic latent image on a surface of the image holding member; developing the electrostatic latent image formed on the surface of the image holding member with an electrostatic image developer to thereby form a toner image; transferring the toner image formed on the surface of the image holding member onto a surface of a transfer medium; and fixing the toner image, wherein the electrostatic image developer is the electrostatic image developer according to any one of (((1))) to (((8))).

What is claimed is:

1. An electrostatic image developer comprising:
a toner A to which silica particles (A) containing an elemental nitrogen-containing compound containing elemental molybdenum are externally added; and
a carrier B including a core material and a coating resin layer that covers the core material and contains inorganic particles,
wherein, in the silica particles (A), the ratio N_{Mo}/N_{Si} of a Net intensity N_{Mo} of elemental molybdenum that is measured by X-ray fluorescence analysis to a Net intensity N_{Si} of elemental silicon that is measured by the X-ray fluorescence analysis is from 0.035 to 0.45 inclusive.

2. The electrostatic image developer according to claim 1, wherein the content of the inorganic particles is from 10% by mass to 50% by mass inclusive based on the total mass of the coating resin layer.

3. The electrostatic image developer according to claim 1, wherein a surface coverage Ca of toner particles in the toner A with the silica particles (A) is from 10% by area to 60% by area inclusive.

4. The electrostatic image developer according to claim 1, wherein a surface coverage Cb of the carrier B with the inorganic particles is from 10% by area to 60% by area inclusive.

5. The electrostatic image developer according to claim 1, wherein a surface coverage Ca of toner particles in the toner A with the silica particles (A) and a surface coverage Cb of the carrier B with the inorganic particles satisfy 0.2≤Ca/Cb≤3.

6. The electrostatic image developer according to claim 5, wherein the surface coverage Ca of the toner particles in the toner A with the silica particles (A) and the surface coverage Cb of the carrier B with the inorganic particles satisfy 0.25≤Ca/Cb≤2.0.

7. The electrostatic image developer according to claim 1, wherein the inorganic particles are silica particles.

8. The electrostatic image developer according to claim 1, wherein the coating resin layer further contains elemental nitrogen-containing resin particles.

9. A process cartridge detachably attached to an image forming apparatus, the process cartridge comprising a developing device that houses the electrostatic image developer according to claim 1 and develops, as a toner image, an electrostatic image formed on a surface of an image holding member with the electrostatic image developer.

10. A process cartridge detachably attached to an image forming apparatus, the process cartridge comprising a developing device that houses the electrostatic image developer according to claim 2 and develops, as a toner image, an electrostatic image formed on a surface of an image holding member with the electrostatic image developer.

11. A process cartridge detachably attached to an image forming apparatus, the process cartridge comprising a developing device that houses the electrostatic image developer according to claim 3 and develops, as a toner image, an electrostatic image formed on a surface of an image holding member with the electrostatic image developer.

12. A process cartridge detachably attached to an image forming apparatus, the process cartridge comprising a developing device that houses the electrostatic image developer according to claim 4 and develops, as a toner image, an electrostatic image formed on a surface of an image holding member with the electrostatic image developer.

13. A process cartridge detachably attached to an image forming apparatus, the process cartridge comprising a developing device that houses the electrostatic image developer according to claim 5 and develops, as a toner image, an electrostatic image formed on a surface of an image holding member with the electrostatic image developer.

14. A process cartridge detachably attached to an image forming apparatus, the process cartridge comprising a developing device that houses the electrostatic image developer according to claim 6 and develops, as a toner image, an electrostatic image formed on a surface of an image holding member with the electrostatic image developer.

15. A process cartridge detachably attached to an image forming apparatus, the process cartridge comprising a developing device that houses the electrostatic image developer according to claim 7 and develops, as a toner image, an electrostatic image formed on a surface of an image holding member with the electrostatic image developer.

16. A process cartridge detachably attached to an image forming apparatus, the process cartridge comprising a developing device that houses the electrostatic image developer according to claim 8 and develops, as a toner image, an electrostatic image formed on a surface of an image holding member with the electrostatic image developer.

17. An image forming apparatus comprising:
an image holding member;
a charging device that charges the image holding member;
an exposure device that exposes the charged image holding member to light to thereby form an electrostatic latent image on the image holding member;
a developing device that develops the electrostatic latent image with an electrostatic image developer to thereby form a toner image;
a transferring device that transfers the toner image from the image holding member onto a transfer medium; and
a fixing device that fixes the toner image,
wherein the electrostatic image developer is the electrostatic image developer according to claim 1.

18. An image forming apparatus comprising:
an image holding member;
a charging device that charges the image holding member;
an exposure device that exposes the charged image holding member to light to thereby form an electrostatic latent image on the image holding member;
a developing device that develops the electrostatic latent image with an electrostatic image developer to thereby form a toner image;
a transferring device that transfers the toner image from the image holding member onto a transfer medium; and
a fixing device that fixes the toner image,
wherein the electrostatic image developer is the electrostatic image developer according to claim 2.

19. An image forming apparatus comprising:
an image holding member;
a charging device that charges the image holding member;
an exposure device that exposes the charged image holding member to light to thereby form an electrostatic latent image on the image holding member;
a developing device that develops the electrostatic latent image with an electrostatic image developer to thereby form a toner image;
a transferring device that transfers the toner image from the image holding member onto a transfer medium; and
a fixing device that fixes the toner image,
wherein the electrostatic image developer is the electrostatic image developer according to claim 3.

20. An image forming method comprising:
charging at least an image holding member;
exposing the charged image holding member to light to thereby form an electrostatic latent image on a surface of the image holding member;
developing the electrostatic latent image formed on the surface of the image holding member with an electrostatic image developer to thereby form a toner image;
transferring the toner image formed on the surface of the image holding member onto a surface of a transfer medium; and
fixing the toner image,
wherein the electrostatic image developer is the electrostatic image developer according to claim 1.
